(19) United States
(12) Patent Application Publication
(10) Pub. No.: US 2012/0113165 A1
(43) Pub. Date: May 10, 2012

(54) PLASMA DISPLAY DEVICE AND DRIVE METHOD FOR A PLASMA DISPLAY PANEL

(75) Inventors: Takahiko Origuchi, Osaka (JP); Hidehiko Shoji, Osaka (JP); Naoyuki Tomioka, Osaka (JP)

(73) Assignee: Panasonic Corporation, Osaka (JP)

(21) Appl. No.: 13/383,304

(22) PCT Filed: Jul. 14, 2010
(86) PCT No.: PCT/JP2010/004561

§ 371 Date: Jan. 10, 2012

(30) Foreign Application Priority Data
Jul. 14, 2009 (JP) 2009-165631

(51) Int. Cl. G09G 3/10; G09G 5/10

(52) U.S. Cl. 345/690; 345/42

(57) ABSTRACT

A stable address discharge is caused by preventing an increase in the scan pulse voltage (amplitude) necessary for causing a stable address discharge, and thereby achieves high image display quality. For this purpose, the following operations are performed. The image display area of a plasma display panel is divided into a plurality of regions. In each region, the rate of the number of discharge cells to be lit with respect to the number of all discharge cells in each region is detected, as a partial light-emitting rate of each region, and the partial light-emitting rate is detected in each subfield. The region having the maximum partial light-emitting rate is detected and set as a first region. The regions adjacent to the first region are set as second regions, and a predetermined offset value is added to the partial light-emitting rates of the second regions so as to provide corrected partial light-emitting rates. Magnitude comparison is performed between the partial light-emitting rates and corrected partial light-emitting rates, and the order of address operations on the respective regions is determined based on the result of the magnitude comparison.

### TECHNICAL FIELD

The present invention relates to a driving method for a plasma display panel, and a plasma display apparatus that are used for a wall-mounted television or a large monitor.

### BACKGROUND ART

A typical AC surface discharge panel used as a plasma display panel (hereinafter, simply referred to as “panel”) has a large number of discharge cells that are formed between a front plate and a rear plate facing each other. The front plate has the following elements:

a plurality of display electrode pairs, each formed of a scan electrode and a sustain electrode, disposed on a front glass substrate parallel to each other; and

a dielectric layer and a protective layer formed so as to cover the display electrode pairs. The rear plate has the following elements:

a plurality of parallel data electrodes formed on a rear glass substrate;

a dielectric layer formed over the data electrodes;

a plurality of barrier ribs formed on the dielectric layer parallel to the data electrodes; and

phosphor layers formed on the surface of the dielectric layer and on the side faces of the barrier ribs. The front plate and the rear plate face each other and are sealed together such that the display electrode pairs and the data electrodes three-dimensionally intersect with each other. A discharge gas containing xenon in a partial pressure ratio of 5%, for example, is charged into the sealed inside discharge space. Discharge cells are formed in portions where the display electrode pairs face the data electrodes. In a panel having such a structure, gas discharge generates ultraviolet rays in each discharge cell. Theses ultraviolet rays excite the phosphors of red color (R), green color (G), and blue color (B) such that the phosphors emit the respective colors for color display.

A subfield method is typically used as a method for driving the panel. In the subfield method, not the brightness obtained by one light emission but the number of light emissions occurring in a unit time (e.g. one field) is controlled for brightness adjustment. For this purpose, in the subfield method, one field is divided into a plurality of subfields, and gradations are displayed by causing light emission or no light emission in each discharge cell in each subfield. Each subfield has an initializing period, an address period, and a sustain period.

In the initializing period, an initializing waveform is applied to each scan electrode so as to cause an initializing discharge in each discharge cell. This forms wall charge necessary for the subsequent address operation, and generates priming particles for stably causing an address discharge (excitation particles for causing an address discharge) in each discharge cell.

In the address period, a scan pulse is applied to the scan electrodes, and an address pulse based on the signals of an image to be displayed is applied to the data electrodes. Thus, an address discharge is caused in a discharge cell to be lit so as to form wall charge therein (hereinafter, this operation being also referred to as “addressing”).

In the sustain period, a number of sustain pulses predetermined for each subfield is alternately applied to display electrode pairs, each formed of a scan electrode and a sustain electrode. Thus, a sustain discharge is caused in the discharge cells having undergone an address discharge, and the phosphor layers in the discharge cells are caused to emit light. Thereby, each discharge cell is caused to emit light at a luminance corresponding to the luminance weight predetermined for each subfield. In this manner, each discharge cell in the panel is caused to emit light at a luminance corresponding to the gradation value of the image signal. Thus, an image is displayed in an image display area.

In this subfield method, the following driving method, for example, can minimize the light emission unrelated to gradation display so as to enhance the contrast ratio of the display image. In the initializing period of one subfield among a plurality of subfields, an all-cell initializing operation for causing an initializing discharge in all the discharge cells is performed. In the initializing periods of the other subfields, a selective initializing operation for causing an initializing discharge only in the discharge cells having undergone a sustain discharge in the immediately preceding sustain period is performed. With these operations, the luminance of a black display area (hereinafter, simply referred to as “luminance of black level”) where no sustain discharge occurs is determined only by the weak light emission in the all-cell initializing operation. Thus, an image of high contrast can be displayed.

Meanwhile, with the recent increase in the screen size and luminance of a panel, the electric power consumption of the panel tends to increase. In a panel of large screen and high definition, the load during driving of the panel increases and this tends to destabilize the discharge. In order to cause a stable discharge, the driving voltage applied to the electrodes is increased. However, increasing the driving voltage further increases the electric power consumption. When the driving voltage or the electric power consumption exceeds the rated values of the components constituting the driver circuits, the circuits can malfunction.

The data electrode driver circuit performs an address operation for applying an address pulse voltage to the data electrodes and causing an address discharge in the discharge cells. For example, when the electric power consumption in the address operation exceeds the rated values of the integrated circuits (ICs) constituting the data electrode driver circuit and the ICs malfunction, an addressing failure can occur. That is, no address discharge occurs in the discharge cells where an address discharge is to be caused, or an address discharge occurs in the discharge cells where no address discharge is to be caused. Thus, in order to suppress the electric power consumption in the address operation, the following method is disclosed (see Patent Literature 1, for example). In this method, the electric power consumption of the data electrode driver circuit is estimated based on image signals, and when the estimated value is equal to or larger than a set value, gradations of the display image are limited.

In the address period, as described above, an address discharge is caused in the discharge cells by applying a scan pulse voltage to the san electrodes and an address pulse voltage to the data electrodes. Thus, it is difficult to cause a stable address operation only with a technique for stabilizing the operation of the data electrode driver circuit disclosed in Patent Literature 1. For a stable address operation, a technique for stabilizing the operation of a circuit for driving the scan electrodes (scan electrode driver circuit) is also important.

Further, the scan pulse voltage is sequentially applied to the respective scan electrodes in the address periods. Thus, especially in a high-definition panel, an increased number of scan electrodes increase the time taken in the address periods. Wall charge formed in the discharge cells by the initializing discharge gradually reduces with a lapse of time. For this reason, the loss of the wall charge in the discharge cells undergoing an address operation in a later part of the address period is larger than the loss of the wall charge in the discharge cells undergoing an address operation in an earlier part of the address period. Thus, the address discharge in the former discharge cells tends to be unstable.

### CITATION LIST

[Patent Literature]
[PTL1]
Unexamined Japanese Patent Publication No. 2000-66638

### SUMMARY OF THE INVENTION

In a driving method for a panel,
the panel having a plurality of discharge cells, each of the discharge cells having a display electrode pair and a data electrode, the display electrode pair having a scan electrode and a sustain electrode,
the panel being driven by a subfield method in which a plurality of subfields is set in one field, each of the subfields has an initializing period, an address period, and a sustain period, and an address operation is performed on the discharge cells by applying a scan pulse to the scan electrodes and applying an address pulse to the data electrodes in the address periods,
the driving method of the present invention includes:
   dividing the image display area of the panel into a plurality of regions, and, in each of the regions, detecting the rate of the number of discharge cells to be lit with respect to the number of all discharge cells in each region, as a partial light-emitting rate of each region, and the partial light-emitting rate is detected in each subfield;
   detecting one of the regions having a maximum partial light-emitting rate, and setting the region as a first region;
   setting other ones of the regions adjacent to the first region as second regions, and adding a predetermined offset value to the partial light-emitting rates of the second regions so as to provide corrected partial light-emitting rates;
   performing magnitude comparison between the partial light-emitting rates and the corrected partial light-emitting rates; and
   based on the result of the magnitude comparison, determining an order of address operations to be performed on the respective regions.

This method can prevent an increase in the scan pulse voltage (amplitude) necessary for causing a stable address discharge and cause a stable address discharge even in a panel of large screen, high definition, and high luminance. Further, the magnitude comparison between the partial light-emitting rates is performed using the corrected partial light-emitting rates obtained by adding an offset value to the partial light-emitting rates of the second regions. This can prevent the region undergoing an address operation first from being adjacent to the region undergoing the address operation in a later part of the order of address operations. Thus, this can prevent a large change in the emission luminance of address discharge between adjacent regions, thereby achieving high image display quality.

A plasma display apparatus of the present invention includes the following elements:
a panel,
   the panel being driven by a subfield method for gradation display in which a plurality of subfields is set in one field, and each of the subfields has an initializing period, an address period, and a sustain period,
   the panel having a plurality of discharge cells, each of the discharge cells having a display electrode pair, the display electrode pair having a scan electrode and a sustain electrode;
a scan electrode driver circuit for applying a scan pulse to the scan electrodes in the address periods;
a partial light-emitting rate detection circuit for dividing the image display area of the panel into a plurality of regions, and, in each of the regions, detecting the rate of the number of discharge cells to be lit with respect to the number of all discharge cells in each region, as a partial light-emitting rate of each region, and the partial light-emitting rate is detected in each subfield; and
a light-emitting rate comparison circuit for performing magnitude comparison between the partial light-emitting rates detected in the partial light-emitting rate detection circuit.
   The light-emitting rate comparison circuit detects one of the regions having a maximum partial light-emitting rate and sets the region as a first region. The light-emitting rate comparison circuit sets other ones of the regions adjacent to the first region as second regions and adds a predetermined offset value to the partial light-emitting rates of the second regions so as to provide corrected partial light-emitting rates. The light-emitting rate comparison circuit performs magnitude comparison between the partial light-emitting rates and the corrected partial light-emitting rates of regions other than the first region. The scan electrode driver circuit performs an address operation first on the first region, and performs an address operation earlier on other regions that have the higher partial light-emitting rates and corrected partial light-emitting rates than the first region, based on the result of the magnitude comparison in the light-emitting rate comparison circuit.

This structure can prevent an increase in the scan pulse voltage (amplitude) necessary for causing a stable address discharge and cause a stable address discharge even in a panel of large screen, high definition, and high luminance. Further, the magnitude comparison between the partial light-emitting rates is performed using the corrected partial light-emitting rates obtained by adding an offset value to the partial light-emitting rates of the second regions. This can prevent the region undergoing address operation first from being adjacent to the region undergoing address operation in a later part of the order of address operations. Thus, this can prevent a large change in the emission luminance of address discharge between adjacent regions, thereby achieving high image display quality.

### BRIEF DESCRIPTION OF DRAWINGS

FIG. 1 is an exploded perspective view showing a structure of a panel in accordance with a first exemplary embodiment of the present invention.

FIG. 2 is an electrode array diagram of the panel in accordance with the first exemplary embodiment.

FIG. 3 is a chart of driving voltage waveforms applied to the respective electrodes of the panel in accordance with the first exemplary embodiment.

FIG. 4 is circuit block diagram of a plasma display apparatus in accordance with the first exemplary embodiment.

FIG. 5 is a circuit diagram showing a configuration of a scan electrode driver circuit of the plasma display apparatus in accordance with the first exemplary embodiment.

FIG. 6 is a schematic diagram showing an example of the connection between regions where partial light-emitting rates are detected and scan integrated circuits (ICs) in accordance with the first exemplary embodiment.

FIG. 7 is a schematic diagram showing an example of the order of address operations of the scan ICs in accordance with the first exemplary embodiment.

FIG. 8 is a characteristic chart showing the relation between an order of address operations of the scan ICs and a scan pulse voltage (amplitude) necessary for causing a stable address discharge in accordance with the first exemplary embodiment.

FIG. 9 is a characteristic chart showing the relation between a partial light-emitting rate and a scan pulse voltage (amplitude) necessary for causing a stable address discharge in accordance with the first exemplary embodiment.

FIG. 10 is a circuit block diagram showing a configuration example of a scan IC switching circuit in accordance with the first exemplary embodiment.

FIG. 11 is a circuit diagram showing a configuration example of SID generation circuits in accordance with the first exemplary embodiment.

FIG. 12 is a timing chart for explaining an operation of the scan IC switching circuit in accordance with the first exemplary embodiment.

FIG. 13 is a circuit diagram showing another configuration example of the scan IC switching circuit in accordance with the first exemplary embodiment.

FIG. 14 is a timing chart for explaining another example of the operation of the scan IC switching circuit in accordance with the first exemplary embodiment.

FIG. 15 is a diagram schematically showing a luminance state of the panel when an address operation is performed on the respective regions on the image display surface of the panel in an order based on partial light-emitting rates.

FIG. 16 is a diagram schematically showing a luminance state of the panel when an address operation is performed on the respective regions of the panel in an order based on partial light-emitting rates and corrected partial light-emitting rates in accordance with a second exemplary embodiment of the present invention.

FIG. 17 is a circuit block diagram showing a configuration example of a light-emitting rate comparison circuit in accordance with the second exemplary embodiment.

### DESCRIPTION OF EMBODIMENTS

Hereinafter, a plasma display apparatus in accordance with exemplary embodiments of the present invention is described with reference to the accompanying drawings.

### First Exemplary Embodiment

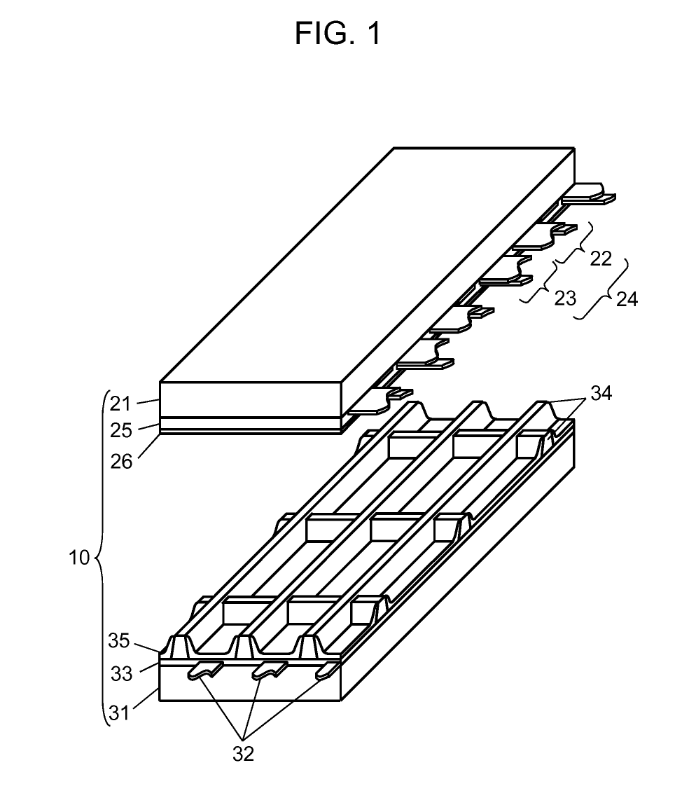

FIG. 1 is an exploded perspective view showing a structure of panel 10 in accordance with the first exemplary embodiment of the present invention. A plurality of display electrode pairs 24, each formed of scan electrode 22 and sustain electrode 23, is disposed on glass front plate 21. Dielectric layer 25 is formed so as to cover scan electrodes 22 and sustain electrodes 23. Protective layer 26 is formed over dielectric layer 25.

In order to lower a discharge start voltage in discharge cells, protective layer 26 is made of a material predominantly composed of MgO. MgO has proven performance as a panel material, and has a large secondary electron emission coefficient and excellent durability when neon (Ne) and xenon (Xe) gas is sealed.

A plurality of data electrodes 32 is formed on rear plate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red color (R), green color (G), and blue color (B) are formed.

Front plate 21 and rear plate 31 face each other such that display electrode pairs 24 intersect with data electrodes 32 with a small discharge space sandwiched between the electrodes. The outer peripheries of the plates are sealed with a sealing material, such as a glass frit. In the inside discharge space, a mixture gas of neon and xenon is sealed as a discharge gas. In this embodiment, a discharge gas having a xenon partial pressure of approximately 10% is used to improve emission efficiency. The discharge space is partitioned into a plurality of compartments by barrier ribs 34. Discharge cells are formed in the intersecting parts of display electrode pairs 24 and data electrodes 32. The discharge cells discharge and emit light so as to display an image on panel 10.

The structure of panel 10 is not limited to the above, and may include barrier ribs in a stripe pattern, for example. The mixture ratio of the discharge gas is not limited to the above numerical value, and other mixture ratios may be used.

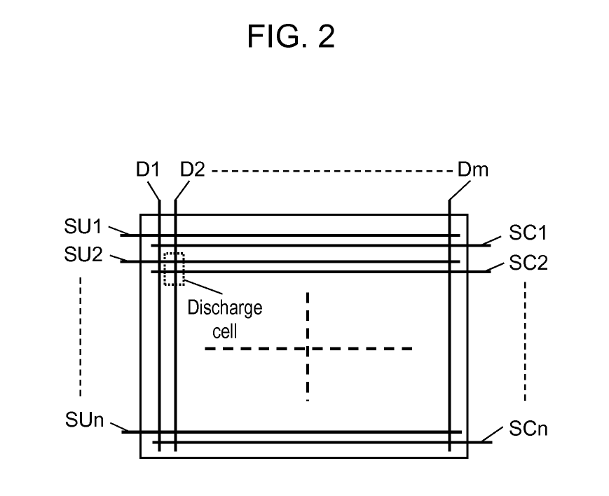

FIG. 2 is an electrode array diagram of panel 10 in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) long in the row direction, and m data electrode D1 through data electrode Dm (data electrodes 32 in FIG. 1) long in the column direction. A discharge cell is formed in the part where a pair of scan electrode SCi (i=1 through n) and sustain electrode SUi intersects with one data electrode Dj (j=1 through m). Thus, m×n discharge cells are formed in the discharge space. The area where m×n discharge cells are formed is the image display area of panel 10.

Next, driving voltage waveforms for driving panel 10 and the operation thereof are outlined. A plasma display apparatus of this embodiment displays gradations by a subfield method. In the subfield method, one field is divided into a plurality of subfields along a temporal axis, a luminance weight is set for each subfield, and the light emission and no light emission in each discharge cell are controlled in each subfield.

In this embodiment, as an example, a description is provided for a structure where one field is formed of eight subfields (the first SF, and the second SF through eighth SF), and the respective subfields have luminance weights of 1, 2, 4, 8, 16, 32, 64, and 128 such that the temporally later subfields have the larger luminance weights. In the initializing period of one subfield among the plurality of subfields, an all-cell initializing operation for causing an initializing discharge in all the discharge cells is performed. In the initializing periods of the other subfields, a selective initializing operation for selectively causing an initializing discharge in the discharge cells having undergone a sustain discharge in the immediately preceding sustain period is performed. These operations can minimize the light emission in a black area where no sustain discharge occurs, and enhance the contrast ratio of an image displayed on panel 10. Hereinafter, a subfield where an all-cell initializing operation is performed is referred to as “all-cell initializing subfield”, and a subfield where a selective initializing operation is performed is referred to as “selective initializing subfield”.

In this embodiment, a description is provided for an example where the all-cell initializing operation is performed in the initializing period of the first SF, and the selective initializing operation is performed in the initializing periods of the second SF through eighth SF. With these operations, the light emission unrelated to image display is only the light emission caused by the discharge in the all-cell initializing operation in the first SF. Thus, luminance of black level, i.e. the luminance of a black display area where no sustain discharge occurs, is determined only by the weak light emission in the all-cell initializing operation. Thereby, an image of high contrast can be displayed on panel 10. In the sustain period of each subfield, sustain pulses equal in number to the luminance weight of the subfield multiplied by a predetermined proportionality factor are applied to respective display electrode pairs 24. This proportionality factor is a luminance magnification.

However, in this embodiment, the number of subfields and the luminance weights of the respective subfields are not limited to the above values. The subfield structure may be switched based on image signals, for example.

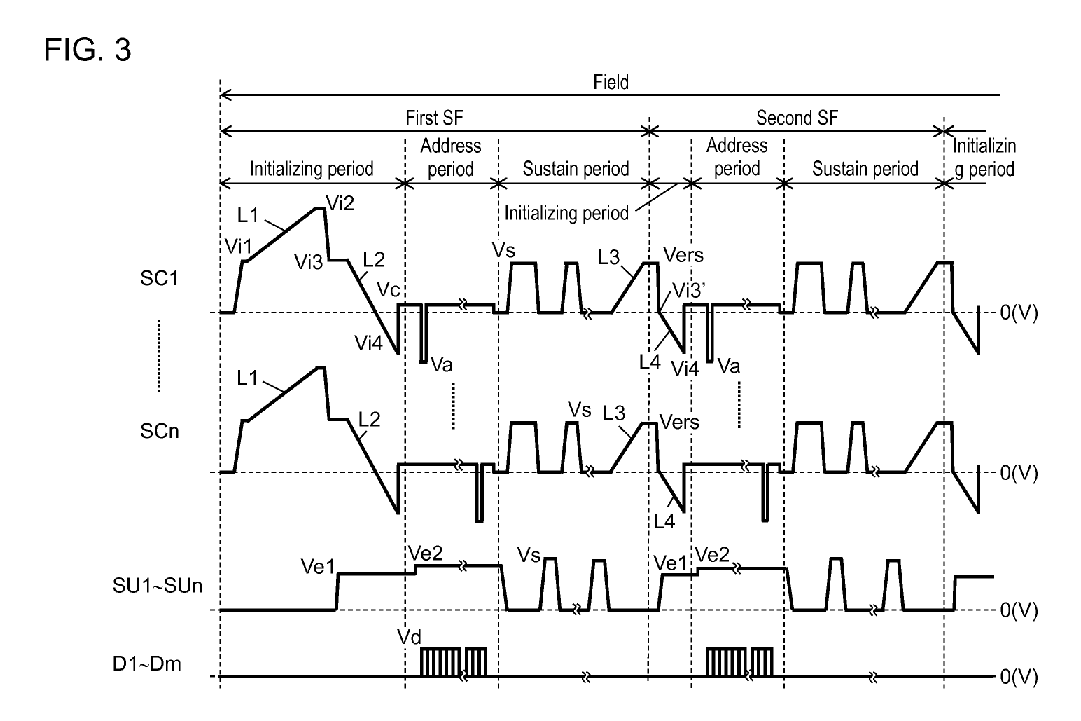

FIG. 3 is a chart of driving voltage waveforms applied to the respective electrodes of panel 10 in accordance with the first exemplary embodiment of the present invention. FIG. 3 shows driving voltage waveforms applied to the following electrodes: scan electrode SC1 for undergoing an address operation first in the address periods; scan electrode SCn for undergoing an address operation last (e.g. scan electrode SC1080) in the address periods; sustain electrode SU1 through sustain electrode SUn; and data electrode D1 through data electrode Dm.

FIG. 3 shows driving voltage waveforms in two subfields. The two subfields are the first subfield (the first SF), i.e. an all-cell initializing subfield, and the second subfield (the second SF), i.e. a selective initializing subfield. The driving voltage waveforms in the other subfields are substantially similar to driving voltage waveforms in the second SF, except for the numbers of sustain pulses generated in the sustain periods. Scan electrode SCi, sustain electrode SUi, and data electrode Dk in the following description show the electrodes selected from the respective electrodes, based on image data (data showing the light emission and no light emission in each subfield).

First, a description is provided for the first SF, i.e. an all-cell initializing subfield.

In the first half of the initializing period of the first SF, 0 (V) is applied to data electrode D1 through data electrode Dm, and sustain electrode SU1 through sustain electrode SUn. Voltage Vi1 is applied to scan electrode SC1 through scan electrode SCn. Voltage Vi1 is set to a voltage lower than a discharge start voltage with respect to sustain electrode SU1 through sustain electrode SUn. Further, a ramp voltage gently rising from voltage Vi1 toward voltage V12 is applied to scan electrode SC1 through scan electrode SCn. Hereinafter, this ramp voltage is referred to as “up-ramp voltage L1”. Voltage V12 is set to a voltage exceeding the discharge start voltage with respect to sustain electrode SU1 through sustain electrode SUn. Examples of the gradient of this up-ramp voltage L1 include a numerical value of approximately 1.3 V/μsec.

While this up-ramp voltage L1 is rising, a weak initializing discharge continuously occurs between scan electrode SC1 through scan electrode SCn and sustain electrode SU1 through sustain electrode SUn, and between scan electrode SC1 through scan electrode SCn and data electrode D1 through data electrode Dm. Then, negative wall voltage accumulates on scan electrode SC1 through scan electrode SCn, and positive wall voltage accumulates on data electrode D1 through data electrode Dm and sustain electrode SU1 through sustain electrode SUn. This wall voltage on the electrodes means voltages generated by the wall charge that accumulates on the dielectric layers covering the electrodes, a protective layer, phosphor layers, or the like.

In the second half of the initializing period, positive voltage Ve1 is applied to sustain electrode SU1 through sustain electrode SUn, and 0 (V) is applied to data electrode D1 through data electrode Dm. A ramp voltage gently falling from voltage V13 to negative voltage V14 is applied to scan electrode SC1 through scan electrode SCn. Hereinafter, this ramp voltage is referred to as “down-ramp voltage L2”. Voltage V13 is set to a voltage lower than the discharge start voltage with respect to sustain electrode SU1 through sustain electrode SUn, and voltage V14 is set to a voltage exceeding the discharge start voltage. Examples of the gradient of this down-ramp voltage L2 include a numerical value of approximately −2.5 V/μsec.

While down-ramp voltage L2 is applied to scan electrode SC1 through scan electrode SCn, a weak initializing discharge occurs between scan electrode SC1 through scan electrode SCn and sustain electrode SU1 through sustain electrode SUn, and between scan electrode SC1 through scan electrode SCn and data electrode D1 through data electrode Dm. This weak discharge reduces the negative wall voltage on scan electrode SC1 through scan electrode SCn and the positive wall voltage on sustain electrode SU1 through sustain electrode SUn, and adjust the positive wall voltage on data electrode D1 through data electrode Dm to a value appropriate for the address operation. In this manner, the all-cell initializing operation for causing an initializing discharge in all the discharge cells is completed.

In the subsequent address period, scan pulse voltage Va is sequentially applied to scan electrode SC1 through scan electrode SCn. Positive address pulse voltage Vd is applied to data electrode Dk corresponding to a discharge cell to be lit among data electrode D1 through data electrode Dm. Thus, an address discharge is selectively caused in the respective discharge cells. At this time, in this embodiment, the order of scan electrodes 22 to be applied with scan pulse voltage Va, or the order of address operations of the ICs for driving scan electrodes 22 is changed based on the detection result in the partial light-emitting rate detection circuit to be described later. The details will be described later. Herein, a description is provided for a case where scan pulse voltage Va is applied from scan electrode SC1 in order.

Specifically, first, voltage Vet is applied to sustain electrode SU1 through sustain electrode SUn, and voltage Vc (voltage Vc=voltage Va+voltage Vsc) is applied to scan electrode SC1 through scan electrode SCn.

Next, negative scan pulse voltage Va is applied to scan electrode SC1 in the first row. Further, positive address pulse voltage Vd is applied to data electrode Dk of a discharge cell to be lit in the first row among data electrode D1 through data electrode Dm. At this time, the voltage difference in the intersecting part of data electrode Dk and scan electrode SC1 is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1 through sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve2−voltage Va). At this time, setting voltage Ve2 to a voltage value slightly lower than the discharge start voltage can make a state where a discharge is likely to occur but does not actually occurs between sustain electrode SU1 and scan electrode SC1. With this setting, a discharge occurring between data electrode Dk and scan electrode SC1 can trigger a discharge between the areas of sustain electrode SU1 and scan electrode SC1 intersecting with data electrode Dk. Thus, an address discharge occurs in the discharge cell to be lit. Positive wall voltage accumulates on scan electrode SC1, and negative wall voltage accumulates on sustain electrode SU1. Negative wall voltage also accumulates on data electrode Dk.

In this manner, address operation is performed to cause an address discharge in the discharge cells to be lit in the first row and to accumulate wall voltage on the respective electrodes. On the other hand, the voltage in the intersecting parts of scan electrode SC1 and data electrode D1 through data electrode Dm applied with no address pulse voltage Vd does not exceed the discharge start voltage, and thus no address discharge occurs. The above address operation is repeated until the operation reaches the discharge cells in the n-th row, and the address period is completed.

In the subsequent sustain period, sustain pulses equal in number to the luminance weight multiplied by a predetermined luminance magnification are alternately applied to display electrode pairs 24. This causes a sustain discharge in the discharge cells having undergone the address discharge, and causes light emission in the discharge cells.

In this sustain period, first, positive sustain pulse voltage Vs is applied to scan electrode SC1 through scan electrode SCn, and a ground electric potential as a base electric potential, i.e. 0 (V), is applied to sustain electrode SU1 through sustain electrode SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs. Thus, the voltage difference between scan electrode SCi and sustain electrode SUi exceeds the discharge start voltage, and a sustain discharge occurs between scan electrode SCi and sustain electrode SUi. Ultraviolet rays generated by this discharge cause phosphor layers 35 to emit light. Negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, 0 (V) as the base electric potential is applied to scan electrode SC1 through scan electrode SCn, and sustain pulse voltage Vs is applied to sustain electrode SU1 through sustain electrode SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi. Similarly, sustain pulses equal in number to the luminance weight multiplied by the luminance magnification are alternately applied to scan electrode SC1 through scan electrode SCn and sustain electrode SU1 through sustain electrode SUn. Thereby, the sustain discharge is continuously caused in the discharge cells having undergone the address discharge in the address period.

After the sustain pulses have been generated in the sustain period, a ramp voltage gently rising from 0 (V) toward voltage Vers is applied to scan electrode SC1 through scan electrode SCn while 0 (V) is applied to sustain electrode SU1 through sustain electrode SUn and data electrode D1 through data electrode Dm. Hereinafter, this ramp voltage is referred to as “erasing ramp voltage L3”.

Erasing ramp voltage L3 is set so as to have a gradient steeper than that of up-ramp voltage L1. Examples of the gradient of erasing ramp voltage L3 include a numerical value of approximately 10 V/μsec. Voltage Vers set to a voltage exceeding the discharge start voltage causes a weak discharge between sustain electrode SUi and scan electrode SCi in a discharge cell having undergone a sustain discharge. This weak discharge continuously occurs in the period during which the voltage applied to scan electrode SC1 through scan electrode SCn rises and exceeds the discharge start voltage. After the rising voltage has reached voltage Vers as a predetermined voltage, the voltage applied to scan electrode SC1 through scan electrode SCn is lowered to 0 (V) as the base electric potential.

At this time, the charged particles generated by this weak discharge accumulate on sustain electrode SUi and scan electrode SCi so as to reduce the voltage difference between sustain electrode SUi and scan electrode SCi. Therefore, in the discharge cells having undergone the sustain discharge, the wall voltage between scan electrode SC1 through scan electrode SCn and sustain electrode SU1 through sustain electrode SUn is reduced to the difference between the voltage applied to scan electrode SCi and the discharge start voltage, i.e. a level of (voltage Vers-discharge start voltage). Thereby, in the discharge cells having undergone the sustain discharge, a part or the whole of the wall voltage on scan electrode SCi and sustain electrode SUi is erased while the positive wall charge is left on data electrode Dk. That is, the discharge caused by erasing ramp voltage L3 works as “erasing discharge” for erasing unnecessary wall charge accumulated in the discharge cells having undergone the sustain discharge. Hereinafter, the final discharge in the sustain period caused by erasing ramp voltage L3 is referred to as “erasing discharge”.

Thereafter, the voltage applied to scan electrode SC1 through scan electrode SCn is returned to 0 (V), and the sustain operation in the sustain period is completed.

In the initializing period of the second SF, driving voltage waveforms where those in the first half of the initializing period of the first SF are omitted are applied to the respective electrodes. Voltage Ve1 is applied to sustain electrode SU1 through sustain electrode SUn, and 0 (V) is applied to data electrode D1 through data electrode Dm. Down-ramp voltage L4, which gently falls from voltage Vi3′ lower than the discharge start voltage (e.g. 0 (V)) toward negative voltage V14 exceeding the discharge start voltage, is applied to scan electrode SC1 through scan electrode SCn. Examples of the gradient of this down-ramp voltage L4 include a numerical value of approximately −2.5 V/μsec.

Thus, a weak initializing discharge occurs in the discharge cells having undergone a sustain discharge in the sustain period of the immediately preceding subfield (the first SF in FIG. 3). This weak initializing discharge reduces the wall voltage on scan electrode SCi and sustain electrode SUi, and adjusts the wall voltage on data electrode Dk to a value appropriate for the address operation. On the other hand, in the discharge cells having undergone no sustain discharge in the sustain period of the immediately preceding subfield, no initializing discharge occurs. In this manner, the initializing operation in the second SF is a selective initializing operation for causing an initializing discharge in the discharge cells having undergone a sustain discharge in the sustain period of the immediately preceding subfield.

In the address period and the sustain period of the second SF, driving voltage waveforms similar to those in the address period and the sustain period of the first SF except for the number of sustain pulses are applied to the respective electrodes. In the third SF and the subfields thereafter, driving voltage waveforms similar to those in the second SF except for the numbers of sustain pulses are applied to the respective electrodes.

The above description has outlined the driving voltage waveforms applied to the respective electrodes of panel 10.

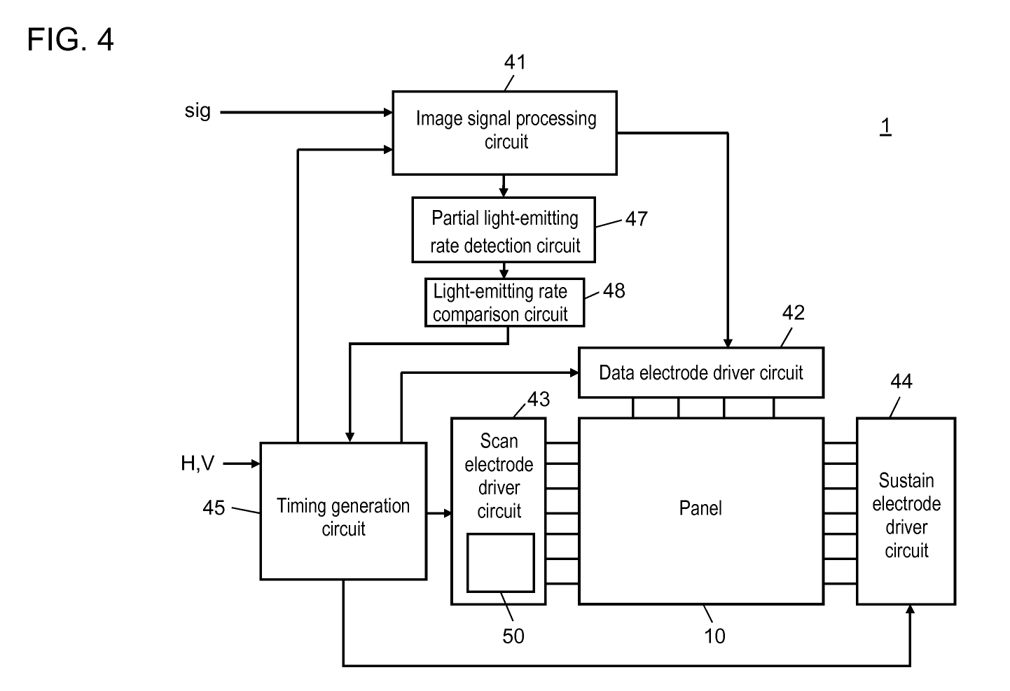

Next, a description is provided for the structure of a plasma display apparatus of this embodiment. FIG. 4 is a circuit block diagram of plasma display apparatus 1 in accordance with the first exemplary embodiment of the present invention. Plasma display apparatus 1 has the following elements:
panel 10;
image signal processing circuit 41;
data electrode driver circuit 42;
scan electrode driver circuit 43;
sustain electrode driver circuit 44;
timing generation circuit 45;
partial light-emitting rate detection circuit 47;
light-emitting rate comparison circuit 48; and
electric power supply circuits (not shown) for supplying electric power necessary for respective circuit blocks.

Image signal processing circuit 41 allocates gradation values to each discharge cell, based on input image signal sig. The image signal processing circuit converts the gradation values into image data showing light emission and no light emission in each subfield.

Partial light-emitting rate detection circuit 47 divides the image display area of panel 10 into a plurality of regions. In each of the regions, the partial light-emitting rate detection circuit detects the rate of the number of discharge cells to be lit with respect to the number of all discharge cells in each region, in each subfield, based on the image data in each subfield. Hereinafter, this rate is referred to as “partial light-emitting rate”. For example, when the number of discharge cells in one region is 518400 and the number of discharge cells to be lit in the region is 259200, the partial light-emitting rate of the region is 50%. For example, partial light-emitting rate detection circuit 47 can detect the light-emitting rate of the discharge cells formed on one display electrode pair 24, as a partial light-emitting rate. However, in this embodiment, a description is provided for an example where a partial light-emitting rate is detected for each region that is formed of a plurality of scan electrodes 22 connected to one of ICs for driving scan electrodes 22 (hereinafter, “scan ICs”).

Light-emitting rate comparison circuit 48 compares the values of the partial light-emitting rate of all the respective regions in the image display area of panel 10 detected in partial light-emitting rate detection circuit 47 with each other, and ranks the regions in decreasing order of value. The light-emitting rate comparison circuit outputs a signal showing the result to timing generation circuit 45 in each subfield.

Timing generation circuit 45 generates various timing signals for controlling the operation of each circuit block, based on horizontal synchronization signal H, vertical synchronization signal V, and the output from light-emitting rate comparison circuit 48. The timing generation circuit supplies the generated timing signals to each circuit block.

Scan electrode driver circuit 43 has an initializing waveform generation circuit (not shown), a sustain pulse generation circuit (not shown), and scan pulse generation circuit 50. The initializing waveform generation circuit generates an initializing waveform voltage to be applied to scan electrode SC1 through scan electrode SCn in the initializing periods. The sustain pulse generation circuit generates a sustain pulse voltage to be applied to scan electrode SC1 through scan electrode SCn in the sustain periods. Scan pulse generation circuit 50 has a plurality of scan electrode driver ICs (scan ICs), and generates scan pulse voltage Va to be applied to scan electrode SC1 through scan electrode SCn in the address periods. Scan electrode driver circuit 43 drives each of scan electrode SC1 through scan electrode SCn in response to the timing signals supplied from timing generation circuit 45. Scan electrode driver circuit 43 switches the scan ICs such that the scan ICs connected to the regions having the higher partial light-emitting rates perform address operations earlier in the address periods. This causes a stable address discharge. The details will be described later.

Data electrode driver circuit 42 converts the data forming image data in each subfield into signals corresponding to respective data electrode D1 through data electrode Dm. The data electrode driver circuit drives each of data electrode D1 through data electrode Dm in response to the timing signals supplied from timing generation circuit 45. In this embodiment, as described above, the order of address operations can be changed in each subfield. Thus, timing generation circuit 45 generates timing signals such that address pulse voltage Vd is generated in data electrode driver circuit 42 in a proper order corresponding to the order of address operations of scan ICs. This allows proper address operations corresponding to a display image.

Sustain electrode driver circuit 44 has a sustain pulse generation circuit and a circuit for generating voltage Ve1 and voltage Vet (not shown), and drives sustain electrode SU1 through sustain electrode SUn in response to the timing signals supplied from timing generation circuit 45.

Next, the details and operation of scan electrode driver circuit 43 are described.

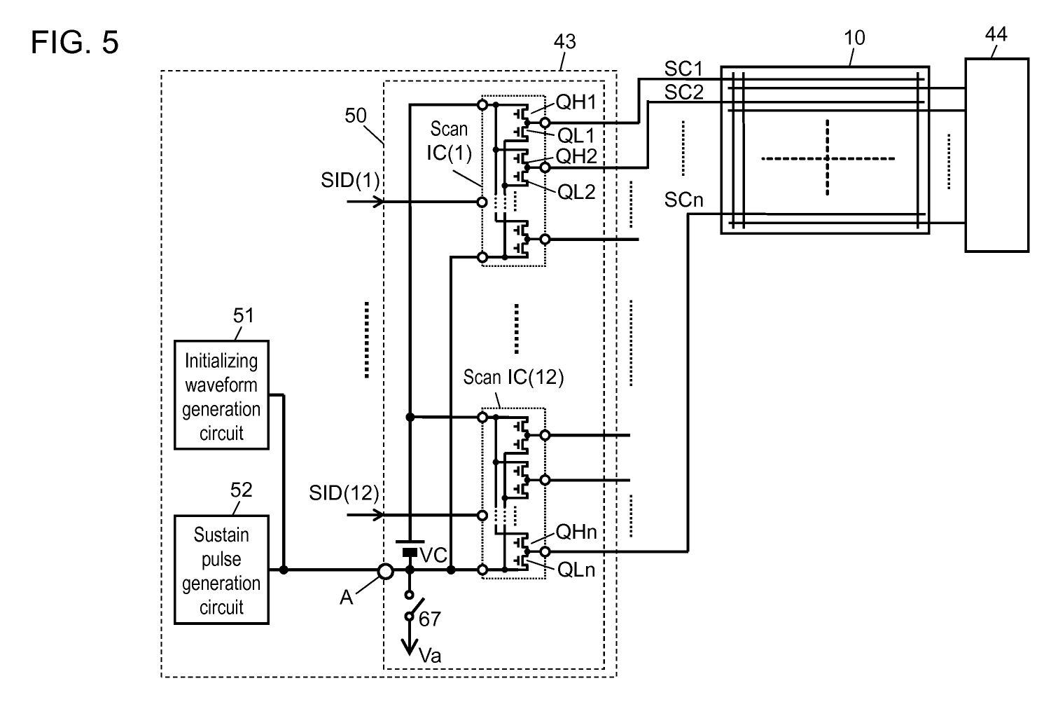

FIG. 5 is a circuit diagram showing a configuration of scan electrode driver circuit 43 of plasma display apparatus 1 in accordance with the first exemplary embodiment of the present invention. Scan electrode driver circuit 43 has scan pulse generation circuit 50, initializing waveform generation circuit 51, and sustain pulse generation circuit 52 on the side of scan electrodes 22. The outputs of scan pulse generation circuit 50 are connected to respective scan electrode SC1 through scan electrode SCn of panel 10.

Initializing waveform generation circuit 51 causes reference electric potential A of scan pulse generation circuit 50 to rise or fall in a ramp form, thereby generating the initializing waveform voltages shown in FIG. 3 in the initializing periods.

Sustain pulse generation circuit 52 changes reference electric potential A of scan pulse generation circuit 50 to voltage Vs or the ground electric potential, thereby generating the sustain pulses shown in FIG. 3.

Scan pulse generation circuit 50 has switch 67, power supply VC, switching element QH1 through switching element QHn, and switching element QL1 through switching element QLn. Switch 67 connects reference electric potential A to negative voltage Va in the address periods. Electric power supply VC generates voltage Vsc. Switching element QH1 through switching element QHn and switching element QL1 through switching element QLn apply scan pulse voltage Va to n scan electrode SC1 through scan electrode SCn, respectively. Specifically, switching element QH1 through switching element QHn and switching element QL1 through switching element QLn are grouped in a plurality of outputs and formed into ICs. These ICs are scan ICs. By setting switching element QHi to OFF, and setting switching element QLi to ON, negative scan pulse voltage Va is applied to scan electrode SCi via switching element QLi. In the following description, the operation of bringing a switching element into conduction is denoted as “ON” and the operation of bringing a switching element out of conduction is denoted as “OFF”. A signal for setting a switching element to ON is denoted as “Hi”, and a signal for setting a switching element to OFF is denoted as “Lo”.

When initializing waveform generation circuit 51 or sustain pulse generation circuit 52 is operated, scan electrode driver circuit 43 sets switching element QH1 through switching element QHn to OFF and switching element QL1 through switching element QLn to ON so as to apply the initializing waveform voltage or sustain pulse voltage Vs to scan electrode SC1 through scan electrode SCn via switching element QL1 through switching element QLn, respectively.

In this embodiment, switching elements for 90 outputs are integrated into one monolithic IC so as to form a scan IC, and panel 10 has 1080 scan electrodes 22. Further, 12 scan ICs form scan pulse generation circuit 50, and drive 1080 scan electrode SC1 through scan electrode SCn. Integrating a large number of switching element QH1 through switching element QHn and switching element QL1 through switching element QLn in this manner can reduce the number of components and thus the area of the substrate on which the components are mounted. However, the above numerical values are only examples, and the present invention is not limited to these numerical values.

In this embodiment, SID(1) through SID(12) output from timing generation circuit 45 are input to respective scan IC(1) through scan IC(12) in the address periods. These SID(1) through SID(12) are operation start signals for causing the scan ICs to start address operations. The order of address operations of scan IC(1) through scan IC(12) is switched in response to SID(1) through SID(12).

For example, in a case where scan IC(1) connected to scan electrode SC1 through scan electrode SC90 performs an address operation after scan IC(12) connected to scan electrode SC991 through scan electrode SC1080 performs an address operation, the following operation is performed.

Timing generation circuit 45 changes SID(12) from Lo (e.g. 0 (V)) to Hi (e.g. 5 (V)), and instructs scan IC(12) to start an address operation. Scan IC(12) detects a change in the voltage of SID(12), thus starting an address operation. First, switching element QH991 is set to OFF, and switching element QL991 is set to ON. Thereby, via switching element QL991, scan pulse voltage Va is applied to scan electrode SC991. After the address operation on scan electrode SC991 is completed, switching element QH991 is set to ON, and switching element QL991 is set to OFF. Subsequently, switching element QH992 is set to OFF, and switching element QL992 is set to ON. Thereby, via switching element QL992, scan pulse voltage Va is applied to scan electrode SC992. The series of address operations is sequentially performed so as to sequentially apply scan pulse voltage Va to scan electrode SC991 through scan electrode SC1080. Thus, scan IC(12) completes the address operation.

After the address operation of scan IC(12) is completed, timing generation circuit 45 changes SID(1) from Lo (e.g. 0 (V)) to Hi (e.g. 5 (V)) and instructs scan IC(1) to start an address operation. Scan IC(1) detects a change in the voltage of SID(1), thus starting an address operation similar to the above. Thereby, scan IC(1) sequentially applies scan pulse voltage Va to scan electrode SC1 through scan electrode SC90.

In this embodiment, the order of address operations of scan ICs is controlled in this manner, using SIDs as operation start signals.

In this embodiment, as described above, the order of address operations of scan ICs is determined based on the partial light-emitting rates detected in partial light-emitting rate detection circuit 47. Then, scan electrode driver circuit 43 causes the scan ICs for driving the regions having the higher partial light-emitting rates to perform an address operation earlier. An example of these operations is described with reference to the accompanying drawings.

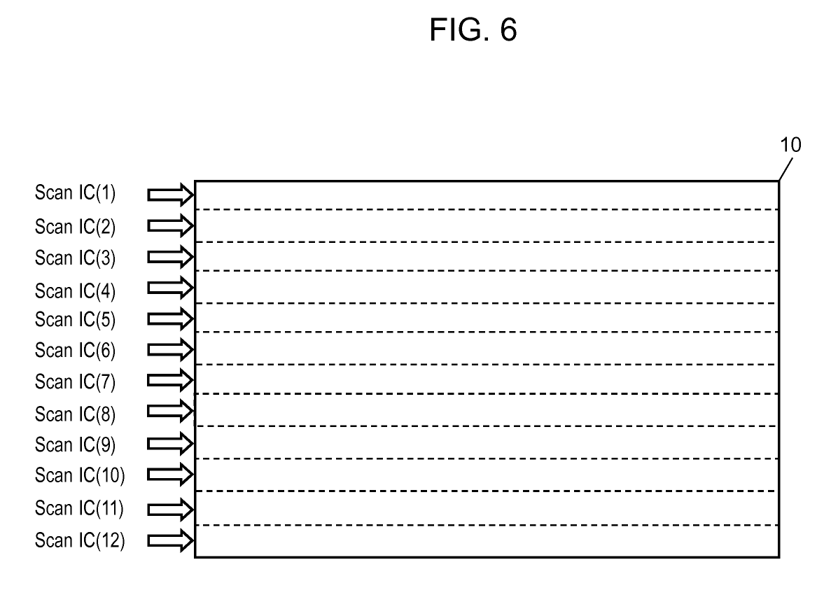

FIG. 6 is a schematic diagram showing an example of the connection between the regions where partial light-emitting rates are detected and the scan ICs in accordance with the first exemplary embodiment of the present invention. FIG. 6 schematically shows how panel 10 is connected to the scan ICs. Each region surrounded by the broken lines in panel 10 shows a region where a partial light-emitting rate is detected. Display electrode pairs 24 are arranged so as to extend in the right and left direction in the drawing, in a manner similar to FIG. 2. In FIG. 6, the broken lines in the image display area of panel 10 are shown only to facilitate discrimination of the respective regions. These broken lines are not actually displayed on panel 10.

As described above, partial light-emitting rate detection circuit 47 sets each region that is formed of a plurality of scan electrodes 22 connected to one scan IC as one region, and detects the partial light-emitting rate of each region. For example, the number of scan electrodes 22 connected to one scan IC is 90, and the number of scan ICs in scan electrode driver circuit 43 is 12 (scan IC(1) through scan IC(12)). In this case, as shown in FIG. 6, partial light-emitting rate detection circuit 47 sets 90 scan electrodes 22 connected to one of scan IC(1) through scan IC(12) as one region, divides the image display area of panel 10 into 12 regions, and detects the partial light-emitting rate of each region. Light-emitting rate comparison circuit 48 compares the values of the partial light-emitting rate detected in partial light-emitting rate detection circuit 47 with each other, and ranks the respective regions in a decreasing order of value. Timing generation circuit 45 generates timing signals based on the ranking. In response to the timing signals, scan electrode driver circuit 43 causes the scan ICs connected to the regions having the higher partial light-emitting rates to perform the address operation earlier.

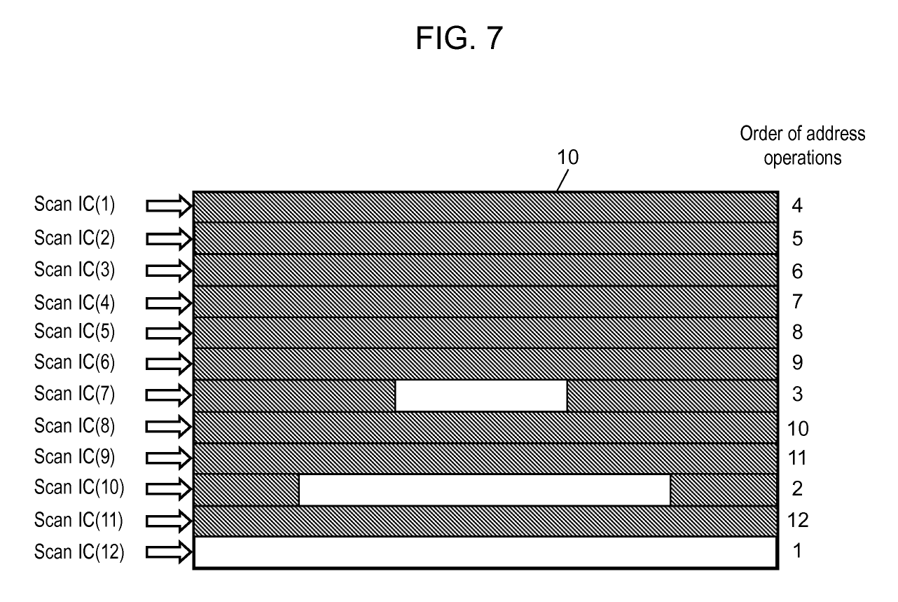

FIG. 7 is a schematic diagram showing an example of the order of address operations of scan IC(1) through scan IC(12) in accordance with the first exemplary embodiment of the present invention. In FIG. 7, the regions where partial light-emitting rates are detected are similar to those shown in FIG. 6. In FIG. 7, the diagonally shaded portion (dark portion) shows a distribution of unlit cells where no sustain discharge occurs, and the white portion not diagonally shaded shows a distribution of lit cells where a sustain discharge occurs. In FIG. 7, the horizontal lines in the image display area of panel 10 are shown to facilitate discrimination of the respective regions. These horizontal lines are not actually displayed on panel 10. Hereinafter, the region connected to scan IC(n) is denoted as “region (n)”.

For example, in a case where lit cells have a distribution as shown in FIG. 7 in a subfield, the region having the highest partial light-emitting rate is region (12) connected to scan IC(12). The region having the highest partial light-emitting rate next to region (12) is region (10) connected to scan IC(10). The region having the highest partial light-emitting rate next to region (10) is region (7) connected to scan IC(7).

At this time, in a conventional address operation, the address operation is switched from scan IC(1) to scan IC(2) and scan IC(3) in order. Thus, scan IC(12) connected to the region having the highest partial light-emitting rate starts address operation last. However, in this embodiment, a scan IC connected to a region having a higher partial light-emitting rate performs the address operation earlier. Thus, in the example of FIG. 7, scan IC(12) performs an address operation first, scan IC(10) performs an address operation next, and scan IC(7) performs an address operation third.

In this embodiment, at an equal partial light-emitting rate, the scan IC connected to scan electrodes 22 in the upper position performs the address operation earlier. Therefore, after scan IC(7) has performed an address operation, scan IC(1), scan IC(2), scan IC(3), scan IC(4), scan IC(5), scan IC(6), scan IC(8), scan IC(9), and scan IC(11) perform the address operation in this order. That is, in the example of FIG. 7, the address operation is performed on region (12), region (10), region (7), region (1), region (2), region (3), region (4), region (5), region (6), region (8), region (9), and region (11) in this order.

In this manner, in this embodiment, a scan IC connected to the region having a higher partial light-emitting rate performs the address operation earlier. This can cause an address discharge earlier in the regions having the higher partial light-emitting rates, thus achieving a stable address discharge. This is due to the following reasons.

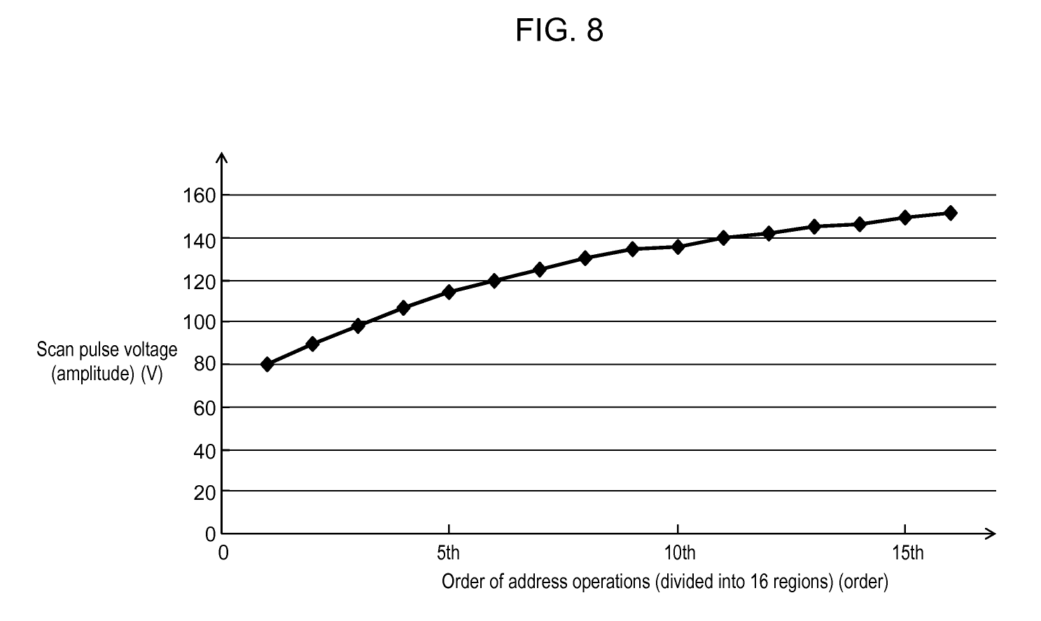

FIG. 8 is a characteristic chart showing the relation between an order of address operations of scan ICs and a scan pulse voltage (amplitude) necessary for causing a stable address discharge in accordance with the first exemplary embodiment of the present invention. In FIG. 8, the vertical axis shows a scan pulse voltage (amplitude) necessary for causing a stable address discharge, and the horizontal axis shows the order of address operations of scan ICs. This experiment is conducted in a structure where one screen is divided into 16 regions, and scan pulse generation circuit 50 has 16 scan ICs so as to drive scan electrode SC1 through scan electrode SCn. Further, it is measured how a scan pulse voltage (amplitude) necessary for causing a stable address discharge changes with the order of address operations of the scan ICs.

As shown in FIG. 8, the scan pulse voltage (amplitude) necessary for causing a stable address discharge changes with the order of address operations of the scan ICs. In a scan IC that performs the address operation in a later part of the order, the scan pulse voltage (amplitude) necessary for causing a stable address discharge is higher. For example, in the scan IC that performs the address operation first, the scan pulse voltage (amplitude) necessary for causing a stable address discharge is approximately 80 (V). In contrast, in the scan IC that performs the address operation last (16th in the example of FIG. 8), the scan pulse voltage (amplitude) necessary for causing a stable address discharge is approximately 150 (V), which is approximately 70 (V) higher than that of the scan IC that performs the address operation first.

This is considered because the wall charge formed in the initializing period gradually reduces with a lapse of time. Address pulse voltage Vd is applied to each data electrode 32 in the address periods (based on a display image). Thus, address pulse voltage Vd is also applied to the discharge cells undergoing no address operation. Such a voltage change also reduces the wall charge. The voltage change in the discharge cells from the initializing discharge to the address discharge is larger in the discharge cells undergoing an address operation at the end of an address period than in the discharge cells undergoing an address operation at the beginning of the address period. Therefore, it is considered that the wall charge further reduces in the discharge cells undergoing an address operation at the end of the address period.

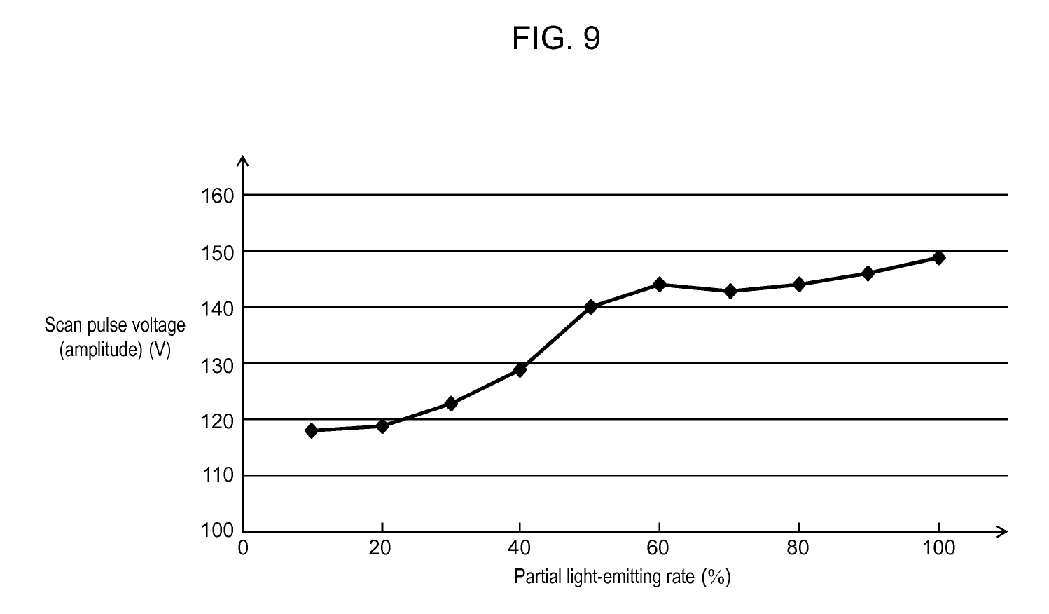

FIG. 9 is a characteristic chart showing the relation between a partial light-emitting rate and a scan pulse voltage (amplitude) necessary for causing a stable address discharge in accordance with the first exemplary embodiment of the present invention. In FIG. 9, the vertical axis shows a scan pulse voltage (amplitude) necessary for causing a stable address discharge, and the horizontal axis shows a partial light-emitting rate. In this experiment, one screen is divided into 16 regions in a manner similar to the measurement of FIG. 8. Further, it is measured how the scan pulse voltage (amplitude) necessary for causing a stable address discharge changes as the rate of lit cells is changed in one of the regions.

As shown in FIG. 9, the scan pulse voltage (amplitude) necessary for causing a stable address discharge changes with the rate of lit cells. As the light-emitting rate increases, the scan pulse voltage (amplitude) necessary for causing a stable address discharge increases. For example, at a light-emitting rate of 10%, the scan pulse voltage (amplitude) necessary for causing a stable address discharge is approximately 118 (V). In contrast, at a light-emitting rate of 100%, the scan pulse voltage (amplitude) necessary for causing a stable address discharge is approximately 149 (V), which is approximately 31 (V) higher than that at a light-emitting rate of 10%.

This is considered because, as the number of lit cells and thus the light-emitting rate increase, discharging current and thus the voltage drop of the scan pulse voltage (amplitude) increase. In addition, when panel 10 of large screen has longer scan electrodes 22 and thus the drive load increases, the voltage drop further increases.

As described above, the scan pulse voltage (amplitude) necessary for causing a stable address discharge is higher in a later part of the order of address operations of scan ICs, i.e. with a longer lapse of time from the initializing operation to the address operation, and at a higher light-emitting rate. Therefore, when a scan IC that performs an address operation in a later part of the order is connected to a region having a higher partial light-emitting rate, the scan pulse voltage (amplitude) necessary for causing a stable address discharge is further increased.

However, when a scan IC is connected to a region having a higher partial light-emitting rate but performs an address operation earlier, the scan pulse voltage (amplitude) necessary for causing a stable address discharge can be made smaller than that when the scan IC performs the address operation later.

Thus, in this embodiment, the image display area of panel 10 is divided into a plurality of regions, a partial light-emitting rate is detected in each region, and the scan ICs connected to the regions having the higher partial light-emitting rates perform the address operation earlier. Thus, the address operation can be performed earlier on a region having a higher partial light-emitting rate. Therefore, the address discharge can be caused in a region having a higher partial light-emitting rate with a lapse of time from the initializing operation to the address operation shorter than that of a region having a lower partial light-emitting rate. This operation can prevent an increase in the scan pulse voltage (amplitude) necessary for causing a stable address discharge. In the experiments conducted by Inventor, it is verified that the structure of this embodiment can reduce the scan pulse voltage (amplitude) necessary for causing a stable address discharge by approximately 20 (V), which depends on the display image.

Next, a description is provided for an example of a circuit for generating SIDs (SID(1) through SID(12) herein), i.e. signals for instructing scan ICs as shown in FIG. 5 to start operation, with reference to the accompanying drawings.

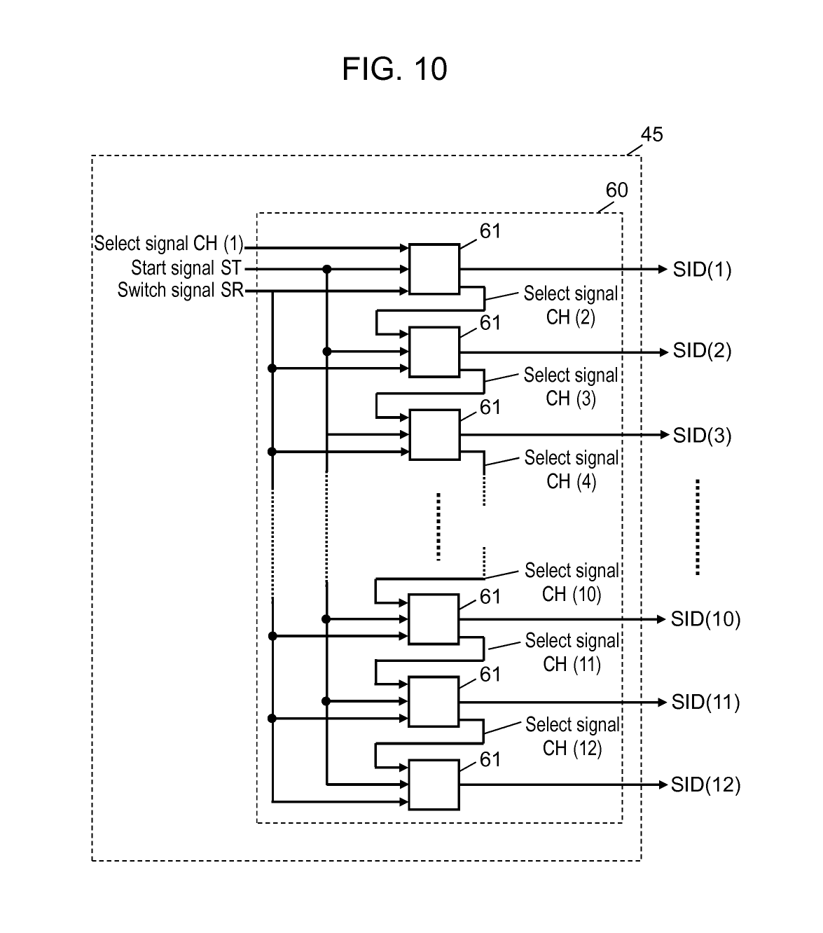

FIG. 10 is a circuit block diagram showing a configuration example of scan IC switching circuit 60 in accordance with the first exemplary embodiment of the present invention. Timing generation circuit 45 has scan IC switching circuit 60 for generating SIDs (SID(1) through SID(12) herein). Though not shown herein, clock signal CK. i.e. the reference of the operation timing of each circuit, is input to each scan IC switching circuit 60.

Scan IC switching circuit 60 has SID generation circuits 61 equal in number to SIDs to be generated (12 circuits, herein), as shown in FIG. 10. Switch signal SR, select signal CH, and start signal ST are input to each SID generation circuit 61. Switch signal SR is a signal which timing generation circuit 45 generates based on the comparison result in light-emitting rate comparison circuit 48. Select signal CH is a signal which timing generation circuit 45 generates in the scan IC selection period in the address period. Start signal ST is a signal which timing generation circuit 45 generates at the start of the address operation of a scan IC. Each SID generation circuit 61 outputs an SID based on the respective input signals.

Each of the signals to be input to SID generation circuits 61 is generated by timing generation circuit 45. Though, as for select signal CH, only first select signal CH(1) is generated by timing generation circuit 45. The other select signals CH are delayed in respective SID generation circuits 61, by a predetermined time, and the delayed signals are used in SID generation circuits 61 at the subsequent stages. For example, select signal CH(1) input to a first one of SID generation circuits 61 is delayed in that SID generation circuit 61 by the predetermined time so as to provide select signal CH(2). Then, this select signal CH(2) is input to SID generation circuit 61 at the subsequent stage. Thereafter, similar operations are sequentially repeated so as to generate other select signals. Therefore, in respective SID generation circuits 61, switch signal SR and start signal ST are input at the same timing, but select signals CH are all input at different timings.

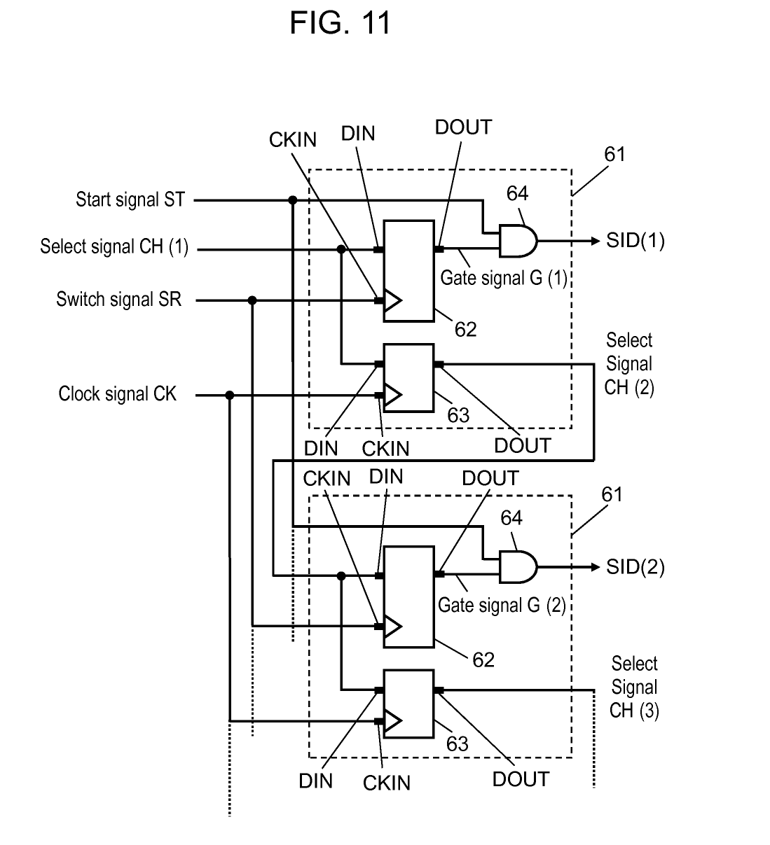

FIG. 11 is a circuit diagram showing a configuration example of SID generation circuits 61 in accordance with the first exemplary embodiment of the present invention. Each SID generation circuit 61 has flip flop circuit (hereinafter, simply referred to as “FF”) 62, delay circuit 63, and AND gate 64.

FF 62 is configured and operates in a manner similar to a generally-known flip flop circuit. FF 62 has clock input terminal CKIN, data input terminal DIN, and data output terminal DOUT. The FF holds the state (Lo or Hi) of data input terminal DIN (select signal CH being input, herein) on the rising edge (at the time of change from Lo to Hi) of the signal input to clock input terminal CKIN (switch signal SR, herein), and outputs the inverted state from data output terminal DOUT, as gate signal G.

In AND gate 64, gate signal G output from FF 62 is input to one input terminal, and start signal ST is input to the other input terminal. The AND gate performs an AND operation on the two signals and outputs the result. That is, only when gate signal G is in the Hi state and start signal ST is in the Hi state, the Hi state is output. Otherwise, the Lo state is output. The output of AND gate 64 is an SID.

Delay circuit 63 is configured and operates in a manner similar to a generally-known delay circuit. Delay circuit 63 has clock input terminal CKIN, data input terminal DIN, and data output terminal DOUT. The delay circuit delays a signal input to data input terminal DIN (select signal CH, herein) by a predetermined cycle (one cycle, herein) of clock signal CK input to clock input terminal CKIN, and outputs the delayed signal from data output terminal DOUT. This output is used as select signal CH in SID generation circuit 61 at the subsequent stage.

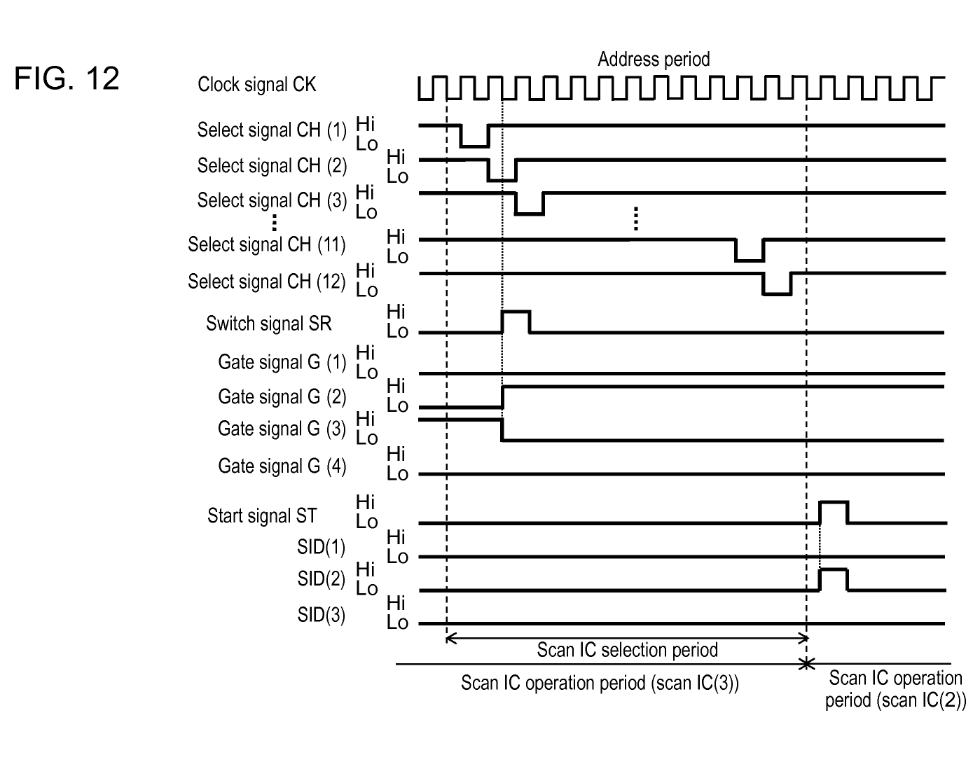

These operations are described with reference to a timing chart. FIG. 12 is a timing chart for explaining an operation of scan IC switching circuit 60 in accordance with the first exemplary embodiment of the present invention. Herein, a description is provided, using the operation of scan IC switching circuit 60 when scan IC(2) performs an address operation right after scan IC(3), as an example. As described above, each of the signals shown herein is generated by timing generation circuit 45, based on the comparison result output from light-emitting rate comparison circuit 48.

In this embodiment, a scan IC for performing an address operation next is determined in the scan IC selection period in the address period. However, the scan IC selection period where the scan IC for performing an address operation first is determined is set immediately before the address period. The scan IC selection period where the scan IC for performing an address operation next is determined is set immediately before the operation of a scan IC in address operation is completed.

In the scan IC selection period, first, select signal CH(1) is input to SID generation circuit 61 for generating SID(1). As shown in FIG. 12, this select signal CH(1) has a pulse waveform of negative polarity in the Hi state normally and in the Lo state only in the period equal to one cycle of clock signal CK. Select signal CH(1) is delayed by one cycle of clock signal CK in SID generation circuit 61 so as to provide select signal CH(2), which is input to SID generation circuit 61 for generating SID(2). Similarly, select signal CH(3) is generated from select signal CH(2), and select signal CH(4) is generated from select signal CH(3), for example. In this manner, select signal CH is delayed by one cycle of clock signal CK, so that select signal CH(3) through select signal CH(12) are generated and input to respective SID generation circuits 61.

As shown in FIG. 12, switch signal SR has a pulse waveform of positive polarity in the Lo state normally and in the Hi state only in the period equal to one cycle of clock signal CK. Timing generation circuit 45 sets switch signal SR to the Hi state so as to generate a positive pulse at the timing when select signal CH among select signal CH(1) through select signal CH(12) that is used to select the scan IC for performing an address operation next changes to the Lo state. Thus, FF 62 outputs, as a gate signal G, a signal that shows the inverted state of the state of select signal CH on the rising edge of switch signal SR input to clock input terminal CKIN.

For example, when scan IC(2) is selected as a scan IC for performing an address operation next, switch signal SR is set to Hi when select signal CH(2) changes to the Lo state in the scan IC selection period, as shown in FIG. 12. At this time, select signals CH except select signal CH(2) are in the Hi state, and thus only gate signal G(2) changes from the Lo state to the Hi state. At this timing, gate signal G(3) changes from the Hi state to the Lo state, and the other gate signals G remain in the Lo state.

Switch signal SR may be generated so as to change the state in synchronization with the falling edge of clock signal CK. This operation can provide a time lag by a half cycle of clock signal CK with respect to a change in the state of select signal CH. Thus, the operation in FF 62 can be stabilized.

Start signal ST has a positive pulse waveform in the Lo state normally and in the Hi state in one cycle of clock signal CK as shown in FIG. 12. At the timing when the address operation of the scan IC is started, start signal ST is set to the Hi state and generated as a positive pulse. Start signal ST is input to respective SID generation circuits 61 in common. However, only AND gate 64 where gate signal G is in the Hi state outputs a positive pulse. In this manner, the scan IC for performing the address operation next can be optionally determined. In the example of FIG. 12, gate signal G(2) is in the Hi state, and thus a positive pulse is generated in SID(2). Therefore, after the operation of scan IC(3) is completed, scan IC(2) starts an address operation.

SIDs can be generated with the circuit configuration as shown above. However, the circuit configuration shown herein is only an example, and the present invention is not limited to this circuit configuration. Any configuration may be used as long as SIDs for instructing the scan ICs to start address operations can be generated.

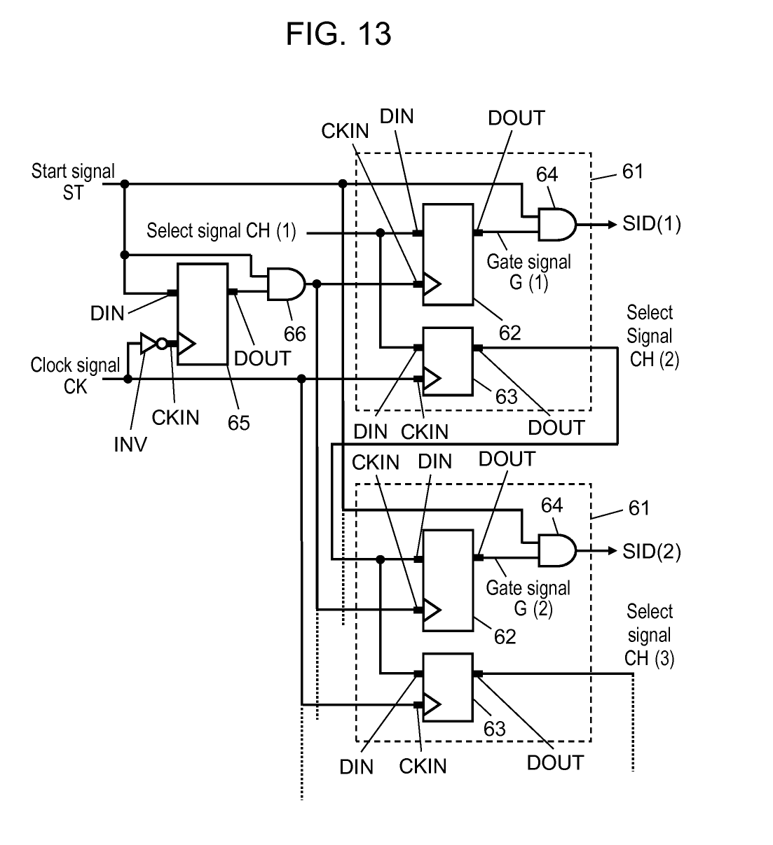

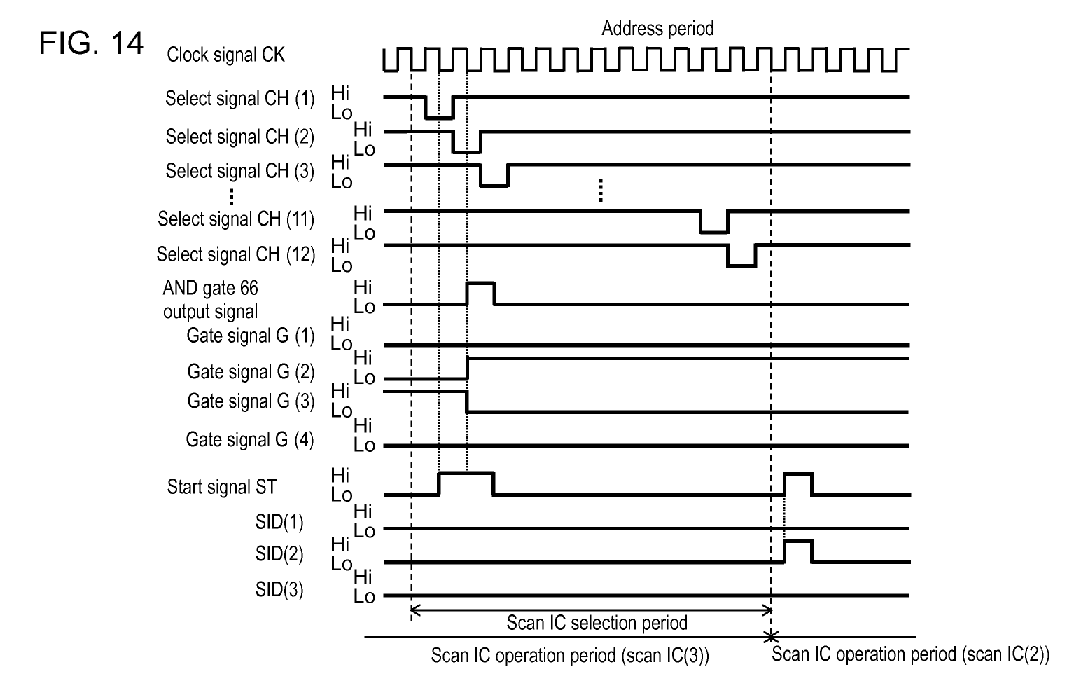

FIG. 13 is a circuit diagram showing another configuration example of the scan IC switching circuit in accordance with the first exemplary embodiment of the present invention. FIG. 14 is a timing chart for explaining another example of the operation of the scan IC switching circuit in accordance with the first exemplary embodiment of the present invention.

For example, as shown in FIG. 13, the circuit may be configured such that start signal ST is delayed in FF 65 by one cycle of clock signal CK, and AND gate 66 performs an AND operation on start signal ST and start signal ST that has been delayed in FF 65 by one cycle of clock signal CK. At this time, it is preferable that clock signal CK that has a reverse polarity made by logic inverter INV is input to clock input terminal CKIN of FF 65.

In this configuration, when a positive pulse in the Hi state in the period equal to two cycles of clock signal CK is generated in start signal ST, AND gate 66 outputs a positive pulse in the Hi state in the period equal to one cycle of clock signal CK. However, when a positive pulse in the Hi state in the period equal to one cycle of clock signal CK is generated in start signal ST, AND gate 66 only outputs the Lo state.

Therefore, as shown in FIG. 14, instead of switch signal SR, a positive pulse in the Hi state in the period equal to two cycles of clock signal CK is generated in start signal ST. Then, a positive pulse output from AND gate 66 can be used as an alternative signal of switch signal SR. That is, in this configuration, start signal ST can serve as switch signal SR in addition to original start signal ST. Thus, the operation similar to the above can be performed without switch signal SR.

As described above, in this embodiment, the image display area of panel 10 is divided into a plurality of regions, the partial light-emitting rate of each region is detected in partial light-emitting rate detection circuit 47, and the address operation is performed earlier on the regions having the higher partial light-emitting rates. This operation can prevent an increase in the scan pulse voltage (amplitude) necessary for causing a stable address discharge, thereby causing a stable address discharge without increasing the scan pulse voltage (amplitude).

In the structure described in this embodiment, each region is set based on scan electrodes 22 connected to one scan IC. However, the present invention is not limited to this structure, and each region may be set by other dividing methods. For example, in a structure where the scan order of each of scan electrodes 22 can be optionally changed, discharge cells on one scan electrode 22 form one region, a partial light-emitting rate is detected in each scan electrode 22, and the order of address operations is changed for each scan electrode 22, based on the detection result.

In the structure described in this embodiment, a partial light-emitting rate is detected in each region, and the address operation is performed earlier on the regions having the higher partial light-emitting rates. However, the present invention is not limited to this structure. For example, the following structure can also be used. The light-emitting rate of the discharge cells formed on one display electrode pair 24 is detected as a line light-emitting rate of each display electrode pair 24, and the highest line light-emitting rate of each region is set as a peak light-emitting rate. Further, the address operation is performed earlier on the regions having the higher peak light-emitting rates.

The polarity of each signal shown in the explanation of the operation of scan IC switching circuit 60 is only an example. Each signal may have the polarity reverse to that shown in the explanation.

### Second Exemplary Embodiment

The luminance in each subfield can be expressed by the following formula. Hereinafter, the brightness caused by one discharge is referred to as “emission luminance”, and the brightness caused by repeated discharges is referred to as “luminance”.

(Luminance in a subfield)=(Luminance caused by sustain discharge in the sustain period of the subfield)+(Emission luminance caused by address discharge in the address period of the subfield)

The discharge intensity of address discharge changes with the order of address operations. This is because the wall charge reduces as the lapse of time from the initializing operation to the address operation increases. Therefore, in a discharge cell undergoing an address operation earlier, the amount of decrease in wall charge is small, and thus the discharge intensity of the address discharge and the emission luminance caused by the address discharge are relatively high. In a discharge cell undergoing an address operation later, the amount of decrease in wall charge is large, and thus the discharge intensity of the address discharge and the emission luminance caused by the address discharge are lower than those in the discharge cell undergoing an address operation earlier.

However, in a subfield where the number of sustain pulses is sufficiently large, the luminance in the sustain period is sufficiently larger than the emission luminance caused by an address discharge. Thus, the emission luminance caused by the address discharge is substantially negligible. The luminance in such a subfield can be expressed by the following formula.

(Luminance of a subfield)=(Luminance caused by sustain discharge in the sustain period of the subfield)

In contrast, in a subfield where the number of sustain pulses is small, the luminance in the sustain period is low and thus the emission luminance caused by an address discharge is relatively large. Thus, the above change in the emission luminance caused by the address discharge can be perceived by the user.

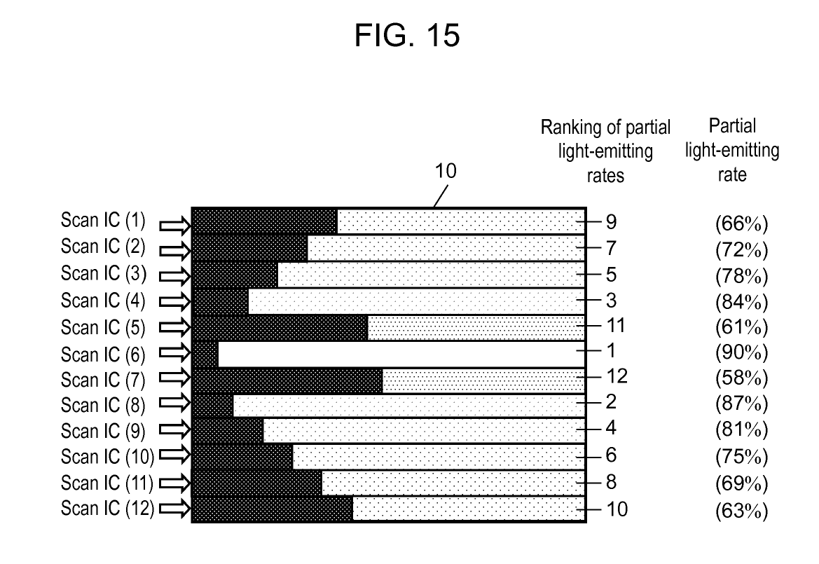

FIG. 15 is a diagram schematically showing a luminance state of panel 10 when an address operation is performed on the respective regions on the image display surface of panel 10 in an order based on partial light-emitting rates. In FIG. 15, the horizontal lines in the image display area of panel 10 are shown to facilitate discrimination of each region, and these horizontal lines are not actually shown in panel 10.

For example, as shown in FIG. 15, the partial light-emitting rates in a subfield are as follows: 66% (region (1)), 72% (region (2)), 78% (region (3)), 84% (region (4)), 61% (region (5)), 90% (region (6)), 58% (region (7)), 87% (region (8)), 81% (region (9)), 75% (region (10)), 69% (region (11)), and 63% (region (12)). At this time, the region having the highest partial light-emitting rate is region (6) having a partial light-emitting rate of 90%. Hereinafter, the region having the highest partial light-emitting rate is referred to as “first region”. In the example of FIG. 15, the partial light-emitting rates of region (5) and region (7) adjacent to the first region rank 11th (61%) and 12th (58%), respectively. Hereinafter, a region adjacent to the first region is referred to as “second region”.

Therefore, in a structure where an address operation is performed earlier on the respective regions having the higher partial light-emitting rates detected in partial light-emitting rate detection circuit 47, the address operation is performed on region (6) first, and on region (5) 11th and on region (7) 12th, which are adjacent to region (6).

As described above, the emission luminance of address discharge is lower in a region undergoing the address operation in a later part of the order of address operations. Therefore, in the example of FIG. 15, when the address operation is performed on the respective regions in the above order, the region having a high emission luminance of address discharge is adjacent to the region having a low emission luminance of address discharge.

A change in the emission luminance caused by a change in the discharge intensity of the address discharge is small, and thus is unlikely to be perceived by the user. Therefore, in a subfield where the number of sustain pulses is sufficiently large, even the occurrence of such a phenomenon causes no problem. However, in a subfield where the number of sustain pulses is small and a change in the emission luminance caused by the address discharge is likely to be perceived, the change in the emission luminance of the address discharge between adjacent regions can be perceived as an unnatural luminance change by the user.

Especially in a dark image having a low averaged picture level or in an image having a relatively small change in gradation values (e.g. an image where a flat pattern of a wall or a sky, for example, appears on the entire surface of the image display surface), even a slight luminance change can be perceived by the user easily.

In order to address this problem, in this embodiment, an offset value is added to the partial light-emitting rates detected in partial light-emitting rate detection circuit 47. This prevents the region undergoing an address operation first from being adjacent to the region undergoing the address operation in a later part of the order of address operations.

Specifically, in this embodiment, in the second regions adjacent to the first region, a predetermined offset value is added to the partial light-emitting rates detected in partial light-emitting rate detection circuit 47. Examples of this offset value include a numerical value of 30% when the maximum value of the partial light-emitting rate is 100% and the minimum value thereof is 0%. Hereinafter, the partial light-emitting rate with an offset value added thereto is referred to as “corrected partial light-emitting rate”. The partial light-emitting rates detected in partial light-emitting rate detection circuit 47 are used for the regions except the second regions, and the corrected partial light-emitting rates with an offset value added thereto are used for the second regions so that the magnitude comparison is performed between the partial light-emitting rates and corrected partial light-emitting rates. Then, an address operation is performed on the respective regions in the order based on the result of the magnitude comparison.

In this embodiment, an address operation is performed first on the first region regardless of the above result of the magnitude comparison. This is due to the following reason.

In the case of some partial light-emitting rates, the corrected partial light-emitting rate of the second region may be higher than the partial light-emitting rate of the first region. At this time, if the address operation is performed first on the second region and a region having a lower partial light-emitting rate is adjacent to the second region, a new part where the region undergoing the address operation first is adjacent to the region undergoing the address operation in a later of the order appears. In order to prevent the occurrence of such a phenomenon, the address operation is performed first on the first region in this embodiment.

Therefore, in this embodiment, the magnitude comparison between the partial light-emitting rates and corrected partial light-emitting rates is performed on the regions except the first region. The address operation is performed first on the first region. Further, the address operation is performed earlier on the regions except the first region that have the higher values of the partial light-emitting rate and corrected partial light-emitting rate.

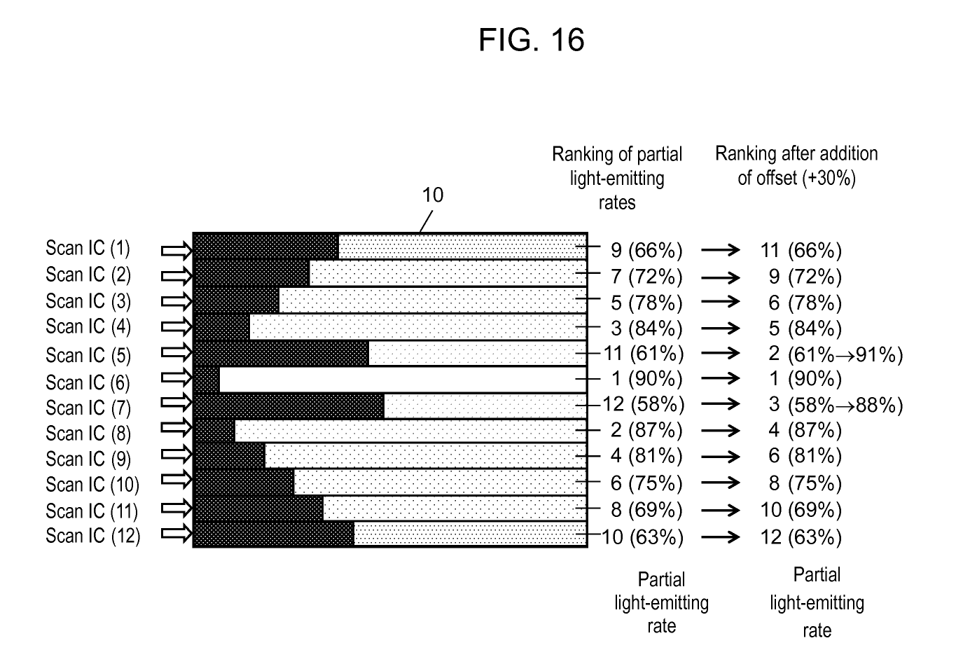

FIG. 16 is a diagram schematically showing a luminance state of panel 10 when an address operation is performed on the respective regions of panel 10 in an order based on partial light-emitting rates and corrected partial light-emitting rates in accordance with the second exemplary embodiment of the present invention. In FIG. 16, the horizontal lines in the display area of panel 10 are shown to facilitate discrimination of each region, and these horizontal lines are not actually shown in panel 10.

For example, as shown in FIG. 15, suppose that the partial light-emitting rates of the respective regions detected in partial light-emitting rate detection circuit 47 are as follows: 66% (region (1)), 72% (region (2)), 78% (region (3)), 84% (region (4)), 61% (region (5)), 90% (region (6)), 58% (region (7)), 87% (region (8)), 81% (region (9)), 75% (region (10)), 69% (region (11)), and 63% (region (12)). In this embodiment, a predetermined offset value is added to the partial light-emitting rates of the second regions. Thus, in the example of FIG. 15, a predetermined offset value (e.g. 30%) is added to the partial light-emitting rates (61% and 58%) of region (5) and region (7), respectively, adjacent to region (6), i.e. the first region.

This corrects the partial light-emitting rate of region (5) from 61% to 91%, and the partial light-emitting rate of region (7) from 58% to 88%. Therefore, as shown in FIG. 16, the partial light-emitting rates of the respective regions are as follows: 66% (region (1)), 72% (region (2)), 78% (region (3)), 84% (region (4)), 91% (region (5)), 90% (region (6)), 88% (region (7)), 87% (region (8)), 81% (region (9)), 75% (region (10)), 69% (region (11)), and 63% (region (12)).

Therefore, the respective regions rank in decreasing order of the value of the partial light-emitting rate as follows: region (5), region (6), region (7), region (8), region (4), region (9), region (3), region (10), region (2), region (11), region (1), and region (12).

In this embodiment, as described above, the address operation is performed first on the first region. Further, the address operation is performed on the regions except the first region in the order based on the result of magnitude comparison between the partial light-emitting rates and corrected partial light-emitting rates.

Thus, the region undergoing the address operation first is region (6), the first region. Further, the address operation is performed on the respective regions after the completion of the address operation on region (6) in the following order: region (5), region (7), region (8), region (4), region (9), region (3), region (10), region (2), region (11), region (1), and region (12). These operations prevent the region undergoing the address operation first from being adjacent to the region undergoing the address operation in a later part of the order of address operations.

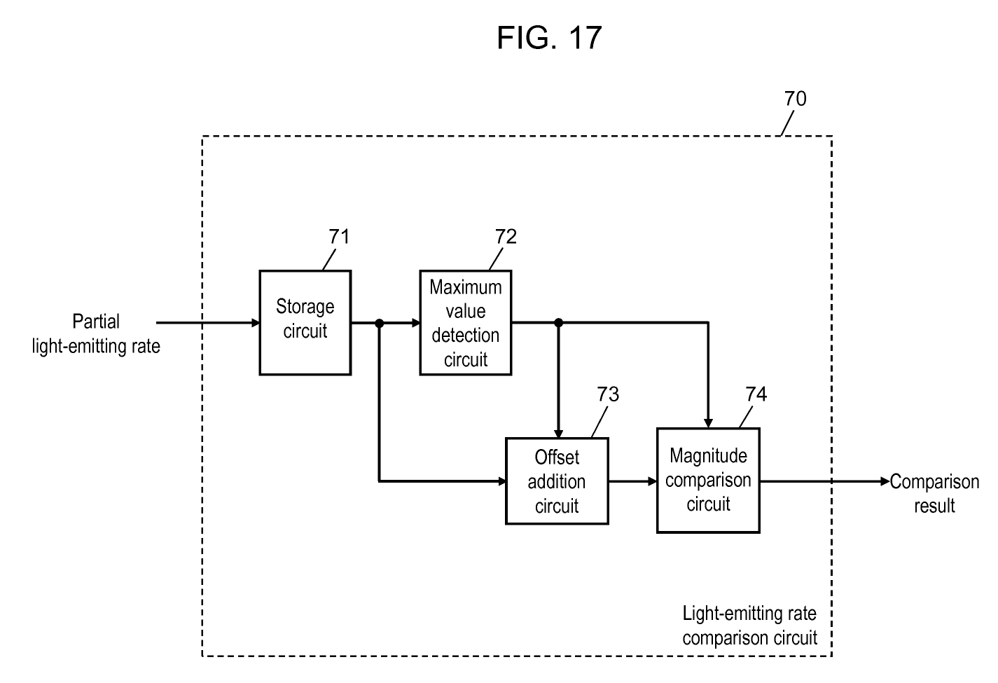

FIG. 17 is a circuit block diagram showing a configuration example of light-emitting rate comparison circuit 70 in accordance with the second exemplary embodiment of the present invention.

Light-emitting rate comparison circuit 70 has storage circuit 71, maximum value detection circuit 72, offset addition circuit 73, and magnitude comparison circuit 74.

Storage circuit 71 stores the partial light-emitting rates of all the regions in one subfield detected in partial light-emitting rate detection circuit 47.

Maximum value detection circuit 72 compares the partial light-emitting rates of all the regions output from storage circuit 71 with each other, and detects region (N) having the maximum partial light-emitting rate. This region (N) is a first region.

Offset addition circuit 73 determines second regions based on the detection result in maximum value detection circuit 72, and adds a predetermined offset value to the partial light-emitting rates of the second regions among the partial light-emitting rates output from storage circuit 71. Specifically, upon receiving the detection result from maximum value detection circuit 72 such that the first region is region (N), offset addition circuit 73 determines that region (N−1) and region (N+1) adjacent to region (N) are second regions. The offset addition circuit 73 adds a predetermined offset value (e.g. 30%) to the partial light-emitting rates of region (N−1) and region (N+1) output from storage circuit 71. Further, the offset addition circuit 73 outputs the addition result as corrected partial light-emitting rates.

Magnitude comparison circuit 74 uses the partial light-emitting rates stored in storage circuit 71, i.e. the partial light-emitting rates detected in partial light-emitting rate detection circuit 47, for the regions except the first region and the second regions. The magnitude comparison circuit 74 uses the corrected partial light-emitting rates with the offset value added thereto in offset addition circuit 73, for the second regions. Thus, the magnitude comparison circuit 74 performs magnitude comparison between the partial light-emitting rates and corrected partial light-emitting rates. Then, the magnitude comparison circuit outputs the result of the magnitude comparison to timing generation circuit 45 at the subsequent stage. In this embodiment, since the first region is set as a region undergoing the address operation first as described above, the magnitude comparison is performed between the partial light-emitting rates and corrected partial light-emitting rates of the regions except the first region.

In this embodiment, with light-emitting rate comparison circuit 70 thus configured, a predetermined offset value is added to the partial light-emitting rates of the second regions adjacent to the first region. The partial light-emitting rates detected in partial light-emitting rate detection circuit 47 are used for the regions except the second regions, and the corrected partial light-emitting rates corrected in offset addition circuit 73 are used for the second regions so that magnitude comparison is performed between the partial light-emitting rates and corrected partial light-emitting rates.

As shown above, in this embodiment, a region having the maximum partial light-emitting rate is detected and set as a first region, and regions adjacent to the first region are set as second regions. A predetermined offset value is added to the partial light-emitting rates of the second regions so as to provide corrected partial light-emitting rates. The detected partial light-emitting rates are used for the regions except the first region and the second regions, and the corrected partial light-emitting rates are used for the second regions so that magnitude comparison is performed between the partial light-emitting rates and corrected partial light-emitting rates. Then, based on the result of the magnitude comparison, the order of address operations on the respective regions except the first region is determined. That is, an address operation is performed first on the first region, and is performed earlier on the regions except the first region that have the higher values of the partial light-emitting rate and corrected partial light-emitting rate.

This prevents the region undergoing an address operation first from being adjacent to the region undergoing the address operation in a later part of the order of address operations, and prevents a large change in the emission luminance of address discharge between the adjacent regions. Therefore, for example, in a subfield where the number of sustain pulses is small and a change in the emission luminance of address discharge is likely to be perceived, an unnatural luminance change can be prevented.

In the structure described in this embodiment, the offset value is set to 30%. However, the present invention is not limited to this structure. Preferably, the offset value is set optimally for the characteristics of the panel, the specifications of the plasma display apparatus, or the like.

In the structure described in this embodiment, an equal offset value is added to the partial light-emitting rates of two second regions adjacent to the first region. However, for example, different offset values may be added to the partial light-emitting rates of the two second regions.

In the present invention, the subfield to which the structure of this embodiment is applied is not specifically limited. For example, the structure of this embodiment may be applied only to a subfield where the number of sustain pulses is equal to or smaller than a predetermined number (e.g. equal to or smaller than 6). Alternatively, the structure of this embodiment may be applied only to a subfield where the rate of the luminance weight in one field is equal to or smaller than a predetermined rate (e.g. equal to or smaller than 3%). In such a case, preferably, the “predetermined number” and the “predetermined rate” are set optimally for the characteristics of the panel, the specifications of the plasma display apparatus, or the like.

In the structures described in the exemplary embodiments of the present invention, each region is set based on scan electrodes 22 connected to one scan IC. However, the present invention is not limited to such a structure, and each region may be set by other dividing methods. For example, in a structure where the order of address operations of scan electrodes 22 can be optionally changed for each scan electrode, discharge cells on one scan electrode 22 form one region, a partial light-emitting rate is detected for each scan electrode 22, and the order of address operations is changed for each scan electrode 22, based on the detection result.

In the structures described in the exemplary embodiments of the present invention, a partial light-emitting rate is detected in each region, the order of address operations is determined based on the detection result, and an address operation is performed earlier on a region having a higher partial light-emitting rate. However, the present invention is not limited to this structure, and the following structure, for example, may be used. The light-emitting rate of the discharge cells formed on one display electrode pair 24 is detected as a line light-emitting rate of each display electrode pair 24, the highest line light-emitting rate of each region is set as a peak light-emitting rate, and an address operation is performed earlier on a region having a higher peak light-emitting rate.

In the structures described in the exemplary embodiments of the present invention, the luminance weights of the respective subfields are set so as to be larger in the temporally later subfields. However, the present invention is not limited to this structure. For example, the luminance weights of the respective subfields may be set so as to be smaller in the temporally later subfields. Alternatively, the luminance weights of the respective subfields may be set such that the luminance weights have a discontinuous magnitude relation.

The driving voltage waveforms of FIG. 3 only show an example in the exemplary embodiments, and the present invention is not limited to these driving voltage waveforms.

The exemplary embodiments of the present invention can be applied to a driving method for a panel called two-phase driving, and the advantages similar to the above can be obtained. In the two-phase driving, scan electrode SC1 through scan electrode SCn are divided into a first scan electrode group and a second scan electrode group. Further, each address period is formed of two address periods: a first address period where a scan pulse is applied to each of scan electrodes 22 belonging to the first scan electrode group; and a second address period where a scan pulse is applied to each of scan electrodes 22 belonging to the second scan electrode group.

The exemplary embodiments of the present invention are also effective in a panel having an electrode structure where scan electrode 22 is adjacent to scan electrode 22 and sustain electrode 23 is adjacent to sustain electrode 23. That is, the electrodes are arranged on front plate 21 in the following order: . . . , a scan electrode, a scan electrode, a sustain electrode, a sustain electrode, a scan electrode, a scan electrode . . . .

In the structures described in the exemplary embodiments of the present invention, erasing ramp voltage L3 is applied to scan electrode SC1 through scan electrode SCn. However, erasing ramp voltage L3 may be applied to sustain electrode SU1 through sustain electrode SUn. Alternatively, instead of erasing ramp voltage L3, a so-called narrow erasing pulse may be used to cause an erasing discharge.

The polarity of each signal shown in the explanation of the operation of scan IC switching circuit 60 is only an example. The polarity reverse to that shown in the explanation can be used.

The specific numerical values in the exemplary embodiments of the present invention are set based on the characteristics of panel 10 that has a 50-inch screen and 1080 display electrode pairs 24, and only show examples in the exemplary embodiments. The present invention is not limited to these numerical values. Preferably, each numerical value is set optimally for the characteristics of panel 10, the specifications of plasma display apparatus 1, or the like. Further, the number of subfields, the luminance weights of the respective subfields, or the like is not limited to the values shown in the exemplary embodiments of the present invention. The subfield structure may be switched based on image signals, for example. Variations are allowed for each numerical value within the range in which the above advantages can be obtained.

### INDUSTRIAL APPLICABILITY

The present invention can cause a stable address discharge by preventing an increase in the scan pulse voltage (amplitude) necessary for causing a stable address discharge, and thereby achieve high image display quality, even in a panel of large screen, high definition, and high luminance. Thus, the present invention is useful as a plasma display apparatus, and a driving method for a panel.

### REFERENCE MARKS IN THE DRAWINGS

1 Plasma display apparatus
10 Panel
21 Front plate
22 Scan electrode
23 Sustain electrode
24 Display electrode pair
25, 33 Dielectric layer
26 Protective layer
31 Rear plate
32 Data electrode
34 Barrier rib
35 Phosphor layer
41 Image signal processing circuit
42 Data electrode driver circuit
43 Scan electrode driver circuit
44 Sustain electrode driver circuit
45 Timing generation circuit
47 Partial light-emitting rate detection circuit
48, 70 Light-emitting rate comparison circuit
50 Scan pulse generation circuit
51 Initializing waveform generation circuit
52 Sustain pulse generation circuit
60 Scan IC switching circuit
61 SID generation circuit
62, 65 FF (Flip flop circuit)
63 Delay circuit
64, 66 AND gate
67 Switch
71 Storage circuit
72 Maximum value detection circuit
73 Offset addition circuit
74 Magnitude comparison circuit

1. A driving method for a plasma display panel,
the plasma display panel having a plurality of discharge cells, each of the discharge cells having a display electrode pair and a data electrode, the display electrode pair having a scan electrode and a sustain electrode,
the plasma display panel being driven by a subfield method in which a plurality of subfields is set in one field, each of the subfields has an initializing period, an address period, and a sustain period, and an address operation is performed on the discharge cells by applying a scan pulse to the scan electrodes and applying an address pulse to the data electrodes in the address periods,
the driving method comprising:
dividing an image display area of the plasma display panel into a plurality of regions, and, in each of the regions, detecting a rate of the number of discharge cells to be lit with respect to the number of all discharge cells in each region, as a partial light-emitting rate of each region, and the partial light-emitting rate is detected in each subfield;
detecting one of the regions having a maximum partial light-emitting rate, and setting the region as a first region;
setting other ones of the regions adjacent to the first region as second regions, and adding a predetermined offset value to the partial light-emitting rates of the second regions so as to provide corrected partial light-emitting rates;
performing magnitude comparison between the partial light-emitting rates and the corrected partial light-emitting rates; and
based on a result of the magnitude comparison, determining an order of the address operations to be performed on the respective regions.

2. The driving method for the plasma display panel of claim 1, wherein the address operation is performed earlier on the regions having the higher partial light-emitting rates and corrected partial light-emitting rates.

3. The driving method for the plasma display panel of claim 1, wherein
the first region is set as a region undergoing the address operation first;
the magnitude comparison between the partial light-emitting rates and the corrected partial light-emitting rates is performed on regions except the first region; and
the address operation is performed earlier on regions having the higher partial light-emitting rates and corrected partial light-emitting rates.

4. A plasma display apparatus comprising:
a plasma display panel,
the plasma display panel being driven by a subfield method for gradation display in which a plurality of subfields is set in one field, and each of the subfields has an initializing period, an address period, and a sustain period,
the plasma display panel having a plurality of discharge cells, each of the discharge cells having a display electrode pair, the display electrode pair having a scan electrode and a sustain electrode;
a scan electrode driver circuit for applying a scan pulse to the scan electrodes in the address periods;
a partial light-emitting rate detection circuit for dividing an image display area of the plasma display panel into a plurality of regions, and, in each of the regions, detecting a rate of the number of discharge cells to be lit with respect to the number of all discharge cells in each region, as a partial light-emitting rate of each region, and the partial light-emitting rate is detected in each subfield; and
a light-emitting rate comparison circuit for performing magnitude comparison between the partial light-emitting rates detected in the partial light-emitting rate detection circuit,
wherein the light-emitting rate comparison circuit detects one of the regions having a maximum partial light-emitting rate and sets the region as a first region, sets other ones of the regions adjacent to the first region as second regions and adds a predetermined offset value to the partial light-emitting rates of the second regions so as to provide corrected partial light-emitting rates, and performs magnitude comparison between the partial light-emitting rates and the corrected partial light-emitting rates of regions other than the first region, and
the scan electrode driver circuit performs an address operation first on the first region, and performs the address operation earlier on other regions that have the higher partial light-emitting rates and corrected partial light-emitting rates than the first region, based on a result of the magnitude comparison in the light-emitting rate comparison circuit.
